(19) United States
(12) Patent Application Publication
(10) Pub. No.: US 2026/0252941 A1
(43) Pub. Date: Aug. 27, 2026

(54) Quantum Error Correction Using Mid-Cycle Single-Qubit Gauge Operators

(71) Applicant: Google LLC, Mountain View, CA (US)

(72) Inventors: Oscar Joe Higgott, Santa Monica, CA (US); Matthew James McEwen, Santa Barbara, CA (US); Dripto Mazumdar Debroy, Los Angeles, CA (US)

(21) Appl. No.: 19/062,764

(22) Filed: Feb. 25, 2025

(51) Int. Cl. G06N 10/70

(52) U.S. Cl. CPC G06N 10/70

(57) ABSTRACT

A method can include measuring, at one or more mid-cycle states of a quantum error correction code executing on a quantum computing system, one or more mid-cycle gauge operators and one or more mid-cycle stabilizers. In the method, the one or more mid-cycle gauge operators comprise one or more single-qubit mid-cycle gauge operators. The method can include performing, based at least in part on a result of the measuring, a quantum error correction operation.

### FIELD

The present disclosure relates generally to systems and methods for quantum computing.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0>+b|1> The “0” and “1” states of a digital computer are analogous to the |0> and |1> basis states, respectively of a qubit.

### SUMMARY

Aspects and advantages of embodiments of the present disclosure will be set forth in part in the following description, or can be learned from the description, or can be learned through practice of the embodiments.

Example aspects of the present disclosure provide an example method for fault-tolerant quantum computing. In some implementations, the example method can include measuring, at one or more mid-cycle states of a quantum error correction code executing on a quantum computing system, one or more mid-cycle gauge operators and one or more mid-cycle stabilizers. In some implementations, the example method can include performing, based at least in part on a result of the measuring, a quantum error correction operation. In the example method, the one or more mid-cycle gauge operators can include one or more single-qubit mid-cycle gauge operators.

Example aspects of the present disclosure provide an example quantum computing system. In some implementations, the example quantum computing system can include quantum hardware comprising a plurality of qubit structures and a plurality of couplers, the plurality of qubit structures arranged in a topological grid. In some implementations, the example quantum computing system can include one or more readout devices configured to perform quantum measurements on the quantum hardware. In some implementations, the example quantum computing system can include one or more control devices configured to cause the quantum computing system to perform example operations. In some implementations, the example operations can include measuring, at one or more mid-cycle states of a quantum error correction code executing on a quantum computing system, one or more mid-cycle gauge operators and one or more mid-cycle stabilizers. In the example operations, the one or more mid-cycle gauge operators can include one or more single-qubit mid-cycle gauge operators. In some implementations, the example operations can include performing, based at least in part on the one or more single-qubit mid-cycle gauge operators, a quantum error correction operation.

Example aspects of the present disclosure provide an example method. In some implementations, the example method can include determining, based at least in part on a set of dropout quantum devices of a set of quantum devices of a quantum computing system, a set of mid-cycle gauge operators. In some implementations, the set of mid-cycle gauge operators can include one or more single-qubit mid-cycle gauge operators. In some implementations, the example method can include determining, based at least in part on the set of dropout quantum devices, a modified quantum error correction code that can be performed without using the dropout quantum devices, wherein the modified quantum error correction code comprises determining one or more mid-cycle stabilizers based at least in part on the one or more single-qubit mid-cycle gauge operators. In some implementations, the example method can include implementing, using the quantum computing system, the modified quantum error correction code.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1A depicts a block diagram of an example quantum error correcting cycle according to example implementations of some aspects of the present disclosure;

FIG. 1B depicts a schematic diagram of an example end-cycle state of an example quantum error correcting cycle according to example implementations of some aspects of the present disclosure;

FIG. 1C depicts a schematic diagram of an example mid-cycle state of an example quantum error correcting cycle according to example implementations of some aspects of the present disclosure;

FIG. 1D depicts a block diagram of an example quantum error correcting cycle according to example implementations of some aspects of the present disclosure;

FIG. 2A depicts a schematic diagram of an example quantum computing system comprising two adjacent dropout couplers according to example implementations of some aspects of the present disclosure;

FIG. 2B depicts a schematic diagram of a plurality of example gauge operators and stabilizers for performing quantum error correction in an example quantum computing system comprising two adjacent dropout couplers according to example implementations of some aspects of the present disclosure;

FIG. 2C depicts a schematic diagram of an example method for combining gauge operators to generate a stabilizer for an example quantum computing system comprising two adjacent dropout couplers according to example implementations of some aspects of the present disclosure;

FIG. 2D depicts a schematic diagram of an example method for combining gauge operators to generate a stabilizer for an example quantum computing system comprising two adjacent dropout couplers according to example implementations of some aspects of the present disclosure;

FIG. 3A depicts a schematic diagram of an example quantum computing system comprising four dropout couplers in a square formation according to example implementations of some aspects of the present disclosure;

FIG. 3B depicts a schematic diagram of a plurality of example gauge operators and stabilizers for performing quantum error correction in an example quantum computing system comprising four dropout couplers in a square formation according to example implementations of some aspects of the present disclosure;

FIG. 3C depicts a schematic diagram of an example method for combining gauge operators to generate a stabilizer for an example quantum computing system comprising four dropout couplers in a square formation according to example implementations of some aspects of the present disclosure;

FIG. 3D depicts a schematic diagram of an example method for combining gauge operators to generate a stabilizer for an example quantum computing system comprising four dropout couplers in a square formation according to example implementations of some aspects of the present disclosure;

FIG. 4A depicts a schematic diagram of an example quantum computing system comprising a dropout qubit structure adjacent to a dropout coupler according to example implementations of some aspects of the present disclosure;

FIG. 4B depicts a schematic diagram of a plurality of example gauge operators and stabilizers for performing quantum error correction in an example quantum computing system comprising a dropout qubit structure adjacent to a dropout coupler according to example implementations of some aspects of the present disclosure;

FIG. 4C depicts a schematic diagram of an example method for combining gauge operators to generate a stabilizer for an example quantum computing system comprising a dropout qubit structure adjacent to a dropout coupler according to example implementations of some aspects of the present disclosure;

FIG. 4D depicts a schematic diagram of an example method for combining gauge operators to generate a stabilizer for an example quantum computing system comprising a dropout qubit structure adjacent to a dropout coupler according to example implementations of some aspects of the present disclosure;

FIG. 5A depicts a schematic diagram of a first view of an example quantum computing system comprising a hexagonal grid of qubits according to example implementations of some aspects of the present disclosure;

FIG. 5B depicts a second schematic diagram of the example quantum computing system comprising the hexagonal grid of qubits of FIG. 5A;

FIG. 6A depicts a schematic diagram of an example quantum computing system comprising a dropout coupler in a first location within a hexagonal grid of qubit structures according to example implementations of some aspects of the present disclosure;

FIG. 6B depicts a schematic diagram of a plurality of example gauge operators and stabilizers for performing quantum error correction in an example quantum computing system comprising a dropout coupler in a first location within a hexagonal grid of qubit structures according to example implementations of some aspects of the present disclosure;

FIG. 6C depicts a schematic diagram of an example method for combining gauge operators to generate a stabilizer for an example quantum computing system comprising a dropout coupler in a first location within a hexagonal grid of qubit structures according to example implementations of some aspects of the present disclosure;

FIG. 6D depicts a schematic diagram of an example method for combining gauge operators to generate a stabilizer for an example quantum computing system comprising a dropout coupler in a first location within a hexagonal grid of qubit structures according to example implementations of some aspects of the present disclosure;

FIG. 6E depicts a schematic diagram of an example quantum computing system comprising a dropout coupler in a second location within a hexagonal grid of qubit structures according to example implementations of some aspects of the present disclosure;

FIG. 6F depicts a schematic diagram of a plurality of example gauge operators and stabilizers for performing quantum error correction in an example quantum computing system comprising a dropout coupler in a second location within a hexagonal grid of qubit structures according to example implementations of some aspects of the present disclosure;

FIG. 6G depicts a schematic diagram of an example method for combining gauge operators to generate a stabilizer for an example quantum computing system comprising a dropout coupler in a second location within a hexagonal grid of qubit structures according to example implementations of some aspects of the present disclosure;

FIG. 6H depicts a schematic diagram of an example method for combining gauge operators to generate a stabilizer for an example quantum computing system comprising a dropout coupler in a second location within a hexagonal grid of qubit structures according to example implementations of some aspects of the present disclosure;

FIG. 7A depicts a schematic diagram of an example quantum computing system comprising a dropout coupler in a third location within a hexagonal grid of qubit structures according to example implementations of some aspects of the present disclosure;

FIG. 7B depicts a schematic diagram of a plurality of example gauge operators and stabilizers for performing quantum error correction in an example quantum computing system comprising a dropout coupler in a third location within a hexagonal grid of qubit structures according to example implementations of some aspects of the present disclosure;

FIG. 7C depicts a schematic diagram of an example method for combining gauge operators to generate a stabilizer for an example quantum computing system comprising a dropout coupler in a third location within a hexagonal grid of qubit structures according to example implementations of some aspects of the present disclosure;

FIG. 7D depicts a schematic diagram of an example method for combining gauge operators to generate a stabilizer for an example quantum computing system comprising a dropout coupler in a third location within a hexagonal grid of qubit structures according to example implementations of some aspects of the present disclosure;

FIG. 8A depicts a schematic diagram of an example quantum computing system comprising a dropout qubit structure in a hexagonal grid of qubit structures according to example implementations of some aspects of the present disclosure;

FIG. 8B depicts a schematic diagram of a plurality of example gauge operators and stabilizers for performing quantum error correction in an example quantum computing system comprising a dropout qubit structure in a hexagonal grid of qubit structures according to example implementations of some aspects of the present disclosure;

FIG. 8C depicts a schematic diagram of an example method for combining gauge operators to generate a stabilizer for an example quantum computing system comprising a dropout qubit structure in a hexagonal grid of qubit structures according to example implementations of some aspects of the present disclosure;

FIG. 8D depicts a schematic diagram of an example method for combining gauge operators to generate a stabilizer for an example quantum computing system comprising a dropout qubit structure in a hexagonal grid of qubit structures according to example implementations of some aspects of the present disclosure;

FIG. 9A depicts a schematic diagram of a first example notation for describing an example method for measuring one or more stabilizers according to example implementations of some aspects of the present disclosure;

FIG. 9B depicts a schematic diagram of a second example notation for describing the example method of FIG. 9A;

FIG. 9C depicts a schematic diagram of a third example notation for describing a first portion of the example method of FIG. 9A;

FIG. 9D depicts a second schematic diagram of a third example notation for describing a second portion of the example method of FIG. 9A;

FIG. 10 depicts a schematic diagram of an example quantum error correction code for a hexagonal topological grid of qubits in the absence of dropout devices according to example implementations of some aspects of the present disclosure;

FIG. 11 depicts a schematic diagram of an example method for combining gauge operators to generate a stabilizer for an example quantum computing system comprising a square grid of qubits having at least one dropout qubit according to example implementations of some aspects of the present disclosure;

FIG. 12 depicts a flow chart diagram of an example method for determining a quantum error correction circuit according to example implementations of some aspects of the present disclosure;

FIG. 13 depicts a flow chart diagram of an example method for quantum error correction according to example implementations of some aspects of the present disclosure;

FIG. 14 depicts a flow chart diagram of an example method for quantum computation with quantum error correction according to example implementations of some aspects of the present disclosure;

FIG. 15 depicts a flow chart diagram of an example method for quantum computation with quantum error correction according to example implementations of some aspects of the present disclosure;

FIG. 16 depicts an example of a quantum computing system according to example aspects of the present disclosure; and

FIG. 17 depicts a block diagram of an example computing system for implementing example aspects of the present disclosure.

### DETAILED DESCRIPTION

Example embodiments according to some aspects of the present disclosure are directed to systems and methods for quantum error correction, such as quantum error correction codes that can adapt to faulty devices in a quantum computing system. For example, an example method can include measuring, at a mid-cycle state of a quantum error correction code, one or more single-qubit mid-cycle gauge operators and one or more stabilizers; and performing one or more error correction operations based on the single-qubit mid-cycle gauge operator(s) and stabilizer(s).

In order to reach error rates that are low enough to perform useful quantum algorithms, quantum computing systems (QCSs) can use quantum error correction (QEC) codes. A QEC code can include, for example, using multiple physical qubit devices to encode a quantum state of one logical qubit. By using multiple physical qubit devices to encode a single quantum state, a logical qubit can be protected from local physical errors associated with any individual physical qubit. According to some estimates, a QCS capable of outperforming a classical computer may require thousands of logical qubits, with each logical qubit potentially being composed of hundreds to thousands of physical qubit devices. In such systems, with large numbers of small and highly sensitive quantum hardware devices, some manufacturing defects may be likely.

In some quantum computing systems, manufacturing defects may cause some quantum hardware devices to be unsuitable for use in a quantum computation. For example, some quantum hardware devices may fail to work at all, while other quantum hardware devices may have an unacceptably high error rate, either temporarily (e.g., due to fluctuating or time-dependent error sources) or permanently. In some instances, it may be necessary or desirable to perform a quantum computation without using some of the quantum hardware devices in a quantum computer. In this disclosure, such unused devices can be referred to as “dropout” devices. Such dropout devices can make quantum error correction difficult, as some alternative quantum error correction codes may be designed for quantum hardware that is connected in an unchanging, repeating grid pattern (e.g., with no dropout devices). In some instances, quantum error correction codes can compensate for dropout devices by “skipping over” the dropout device and some neighboring devices, and continuing the quantum error code in a region without dropout devices. However, this approach may not be optimal, as it may leave some usable quantum hardware devices unused, and may reduce an effective size of a quantum computing system (e.g., distance or spacelike distance of an error correction code; effective number of physical qubits used per logical qubit, effective number of stabilizers per logical qubit, effective number of logical qubits used, etc.), thereby reducing the computational power of the quantum computing system.

The present disclosure describes systems and methods for performing quantum error correction in the presence of dropout devices, with less reduction in the effective size of the quantum computing system compared to some alternative methods. For example, for some dropout couplers (devices used to connect neighboring physical qubits together), some example methods described herein can perform quantum error correction without any reduction in an effective size of the quantum computing system. For some other dropout couplers and dropout qubit devices, some example methods described herein can perform quantum error correction with less reduction in an effective size of the quantum computing system compared to some alternative methods.

A quantum error correction code can include, for example, one or more error correction cycles, wherein a quantum computing system can cycle through multiple states in each error correction cycle. In some instances, a quantum error correction code can include a starting state corresponding to a rotated error correction code; a mid-cycle state corresponding to an unrotated error correction code; and an ending state corresponding to the rotated error correction code.

In some instances, example methods of quantum error correction in the presence of dropout devices can include performing error correction based on measurements performed at a mid-cycle state of a quantum error correction code. For example, in some instances, measurements performed at the mid-cycle state can include measurements of one or more one-qubit, two-qubit, three-qubit, or four-qubit quantum states (i.e., weight-1, weight-2, weight-3, and weight-4 measurements). In some instances, a multi-qubit measurement can be a stabilizer measurement or a gauge operator measurement, while a single-qubit measurement can be a gauge operator measurement. In some instances, two or more gauge operator measurements (e.g., adjacent gauge operator measurements, gauge operator measurements performed in a same X/Z basis, etc.) can be combined (e.g., multiplied according to a tensor product operation, etc.) to generate a corresponding stabilizer (e.g., stabilizer that commutes with all stabilizers of a quantum stabilizer code, etc.). In this manner, for instance, a plurality of stabilizers can be obtained, and the plurality of stabilizers can be used to perform quantum error correction according to a quantum error correction code (e.g., stabilizer code such as surface code, etc.).

In some instances, a set of gauge operator measurements and stabilizer measurements can include measuring, for each of a plurality of local detection regions (e.g., four-qubit detection regions, etc.) of a quantum computing system at a mid-cycle state, a gauge operator or stabilizer associated with each connected subset (e.g., strict subset, full set, etc.) of qubits of the local detection region, such as each subset that can be represented by a connected graph with each operational qubit (i.e., non-dropout qubit) represented as a graph node and each operational coupler (i.e., non-dropout coupler) represented as an edge between the nodes. In some instances, a measurement of a strict subset of qubits of a local detection region can be a gauge operator, whereas a measurement of a full set of qubits of a local detection region can be either a gauge operator or a stabilizer, depending on whether the measurement shares a qubit with a neighboring gauge operator measurement in an opposite X or Z basis.

In some instances, measuring a plurality of mid-cycle gauge operators and stabilizers can include, for example, folding a multi-qubit state associated with a gauge operator or stabilizer into a single qubit; measuring the qubit (e.g., measuring an eigenvalue of a multi-qubit operator, measuring the qubit in the parity of the multi-qubit gauge operator or stabilizer, etc.); and unfolding to return to the mid-cycle state. For example, in some instances, a pair of first CNOT gates can “fold” a weight-4 mid-cycle stabilizer into two qubits along an edge of a square detecting region associated with the stabilizer, and a second CNOT gate can subsequently fold the resulting weight-2 operator into a single qubit, which can be measured and reset. Subsequently, a set of CNOT gates can reverse the prior CNOT operations to “unfold” the state into the original weight-4 footprint, thereby returning to a mid-cycle state.

In some instances, a plurality of such measurement cycles comprising a contraction, measurement, and expansion can be performed at each mid-cycle state until all relevant gauge operators and stabilizers have been measured. For example, in some instances, pairs of neighboring regions that share a qubit pair may be measured simultaneously if the neighboring regions are “folded” using identical CNOT gates on the shared qubit pair. In contrast, pairs of neighboring measurements that require a shared qubit pair to be in different states can be performed in different measurement cycles.

In some instances, a set of gauge operator measurements and stabilizer measurements to be performed on a local region of a quantum computing system can depend on a number, type, and configuration of dropout devices in the local region, along with a topology of a grid of qubits of the quantum computing system. For example, in a local region with no dropout devices, a stabilizer (e.g., four-qubit stabilizer, etc.) can be directly measured and used to perform quantum computation as part of a stabilizer code. In a local region with one or more dropout devices, the set of measurements to be performed can depend on a topology of the qubit grid. For example, the present disclosure describes some example systems and methods for quantum error correction in quantum computing systems with square grid layouts, and in example quantum computing systems with hexagonal grid layouts.

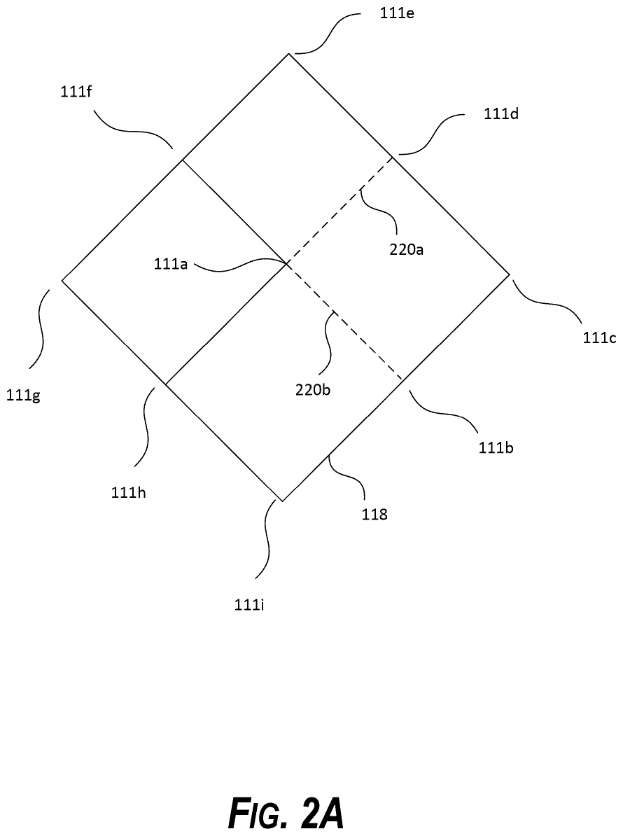

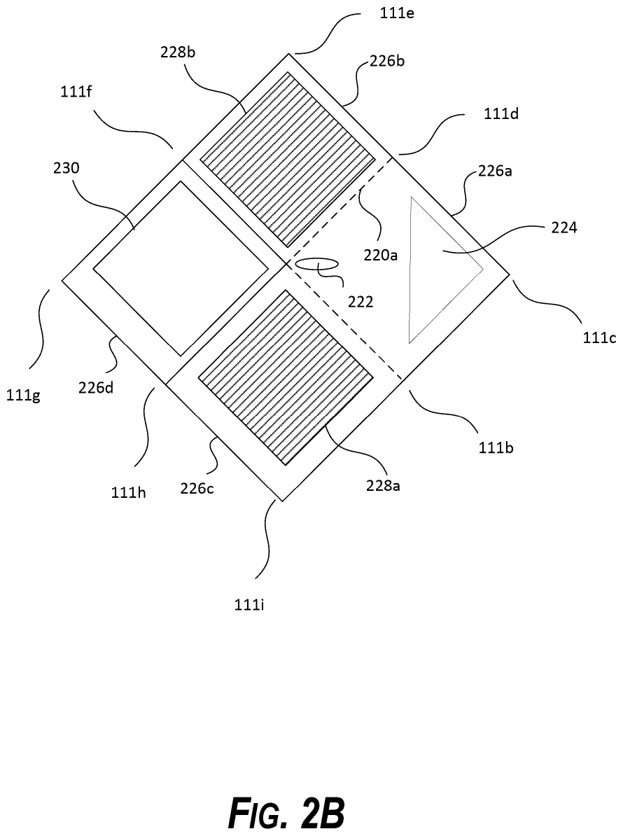

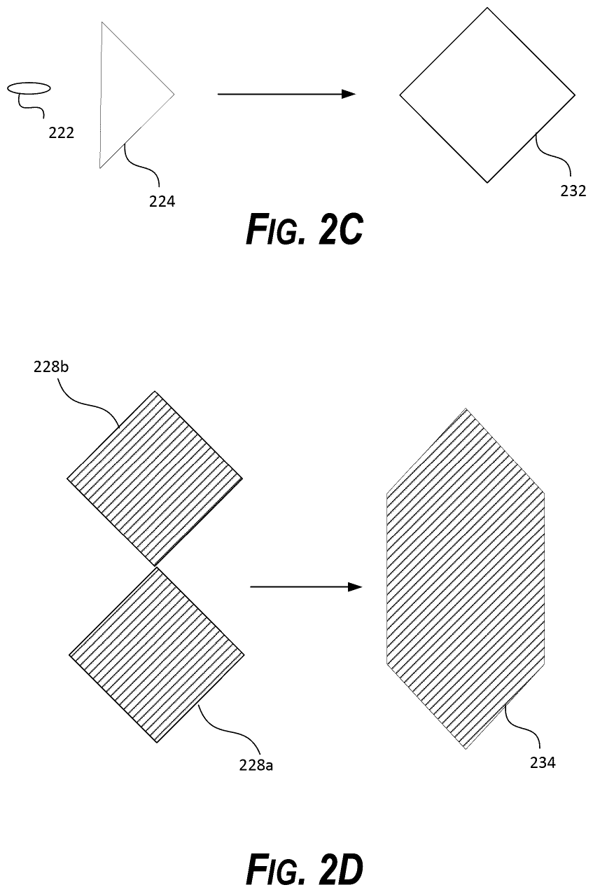

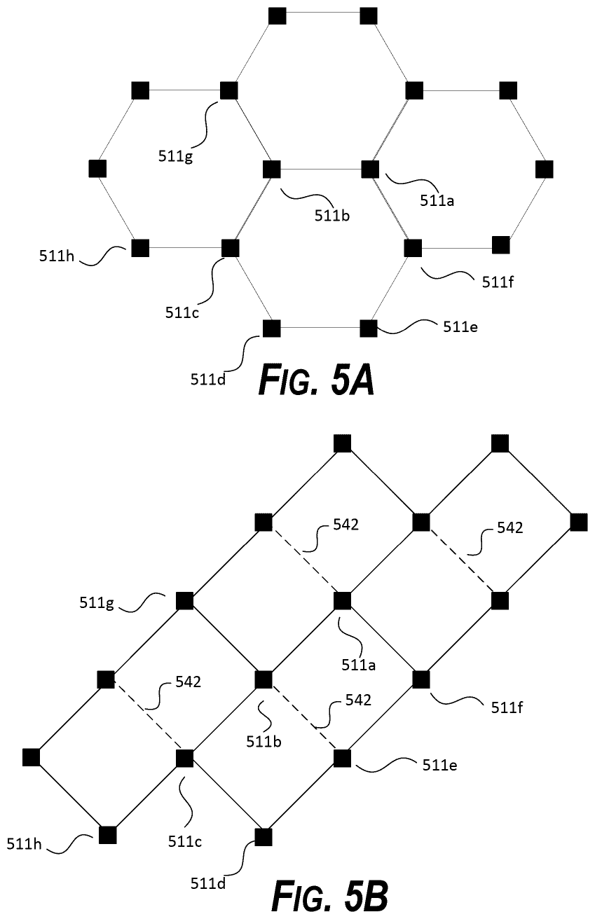

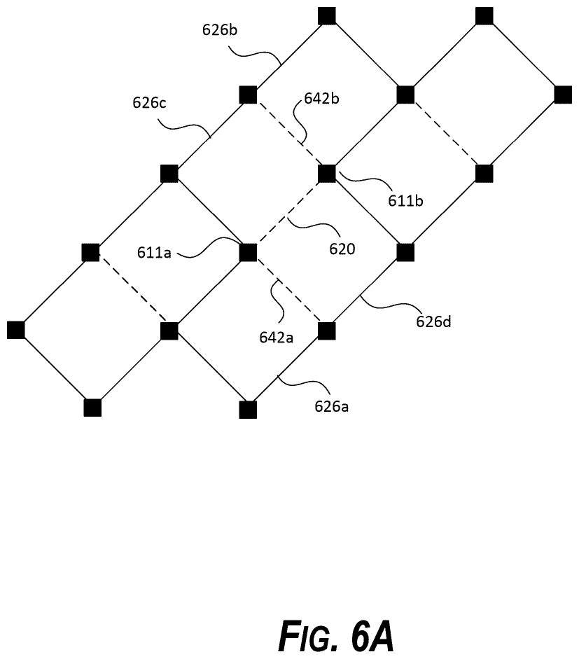

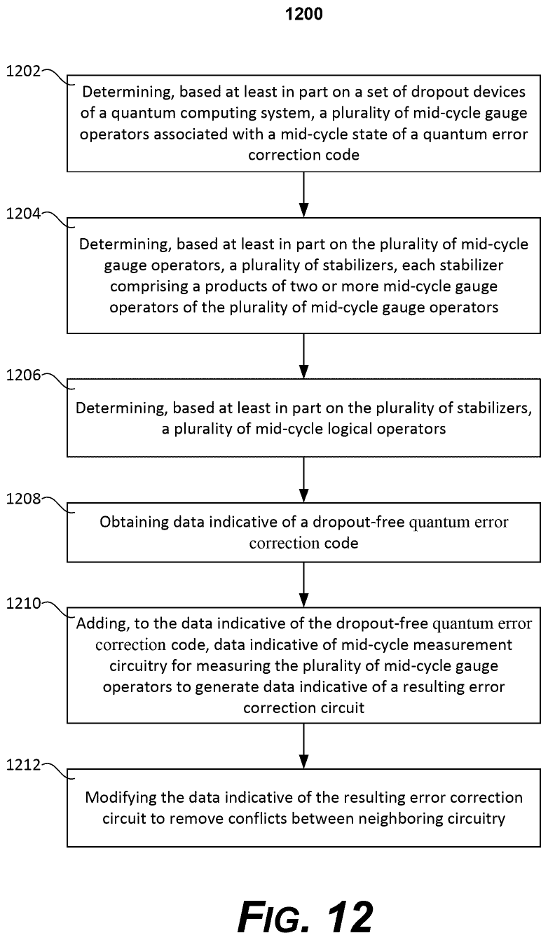

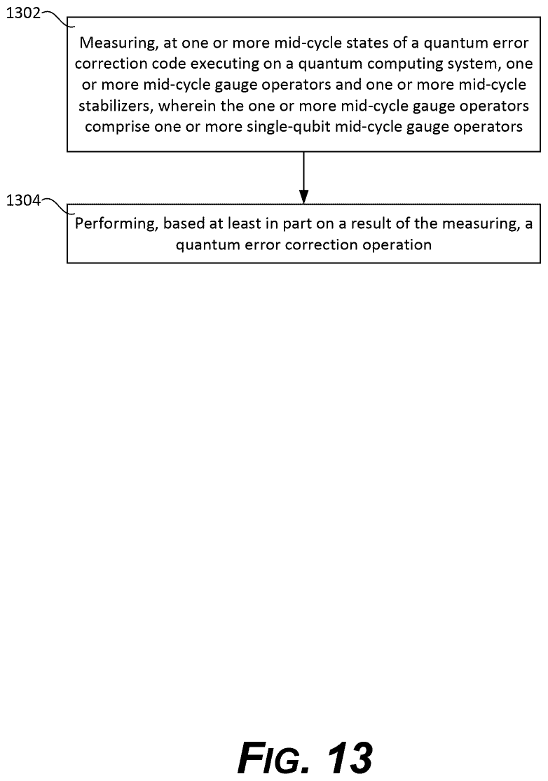

In a square grid layout, in a local region with two or more dropout devices, one-qubit gauge operator(s) can be measured and combined with other gauge operator(s) (e.g., one-, two-, or three-qubit gauge operator(s) depending on a type and location of the dropout devices) to generate a corresponding stabilizer. Further details of specific configurations of multi-dropout-device quantum error correction in a square grid are provided below with respect to FIGS. 2A-4D. Similarly, in a hexagonal grid layout in local regions with one or more dropout devices, one-qubit gauge operator(s) can be measured and combined with other gauge operator(s) to generate stabilizer(s). Further details of specific configurations of quantum error correction in local region(s) of a hexagonal grid with one or more dropout devices are provided below with respect to FIGS. 5A-9D. In a square grid layout, in a local region with one dropout qubit, a plurality of three-qubit gauge operators can be measured, and a plurality of stabilizers can be determined based on the gauge operators. In a local region of a square grid with only one dropout coupler, a four-qubit stabilizer can be directly measured using only three couplers. Further details of some example implementations of one-dropout-device quantum error correction in a square grid are discussed below with respect to FIGS. 10-11. In some instances, quantum error correction codes for dropout configurations not expressly depicted herein can be determined according to one or more methods described below with respect to FIGS. 10-12.

Example embodiments according to some aspects of the present disclosure can provide for a number of technical effects and benefits, such as improvements to computing technology (e.g., quantum computing technology). For example, in some instances, systems and methods according to some aspects of the present disclosure can provide quantum error correction in a square grid with less reduction in an effective size of the quantum computing system (e.g., distance or spacelike distance of a quantum error correction code) compared to some alternative implementations. As another example, in some instances, systems and methods according to some aspects of the present disclosure can provide quantum error correction in a hexagonal grid of qubits comprising one or more dropout devices (e.g., dropout qubits, dropout couplers), whereas some alternative implementations may be unsuitable for use in hexagonal grids, as a single dropout coupler may lead to a chain reaction of cascading dropouts in some alternative error correction implementations. As another example, in some instances, systems and methods according to some aspects of the present disclosure can provide improved quantum error correction, such as a reduced logical error rate for a given physical error rate compared to some alternative implementations.

In some instances, systems and methods according to some aspects of the present disclosure can provide quantum error correction in a square grid with less reduction in a quantum error correction code distance compared to some alternative implementations. As a non-limiting illustrative example, in some local regions with two dropout couplers connected to the same qubit, some alternative error correction methods may lose distance in both an X direction (i.e., in an X basis) and a Z direction (Z basis). In contrast, systems and methods according to some aspects of the present disclosure can lose distance in only one basis, rather than two bases, for local regions having the same two-dropout-coupler configuration. Similarly, in some local regions with four dropout couplers in a square formation, and in some local regions with a dropout qubit adjacent to a dropout coupler, systems and methods according to some aspects of the present disclosure can lose distance in only one basis, whereas some alternative implementations may lose distance in both an X basis and a Z basis.

In some instances, systems and methods according to some aspects of the present disclosure can provide quantum error correction in a hexagonal grid of qubits comprising one or more dropout devices (e.g., dropout qubits, dropout couplers), whereas some alternative implementations may be unsuitable for use in hexagonal grids, as a single dropout coupler may lead to a chain reaction of cascading dropouts in some alternative error correction implementations. For example, in some alternative implementations, an example alternative method for handling local regions adjacent to a qubit that is only connected to two working (i.e., non-dropout) coupler devices can include dropping the qubit, and performing quantum error correction using only qubits with three or more connected couplers. However, in a hexagonal grid, each qubit may begin with only three coupler devices connected to it, meaning that a single dropout coupler can cause some alternative implementations to drop both qubits connected to the coupler. However, dropping a qubit may entail dropping every coupler connected to that qubit, and dropping additional couplers will cause additional qubits to be dropped, leading to a chain reaction wherein one faulty coupler can cause an entire region of quantum hardware to be dropped, causing a potentially very large distance loss for only one faulty coupler. In contrast, systems and methods according to some aspects of the present disclosure can provide quantum error correction for qubits in a hexagonal grid, with limited distance loss for single-device dropout. For example, systems and methods according to some aspects of the present disclosure can compensate for single-coupler dropout in a hexagonal grid with a distance loss of one in either one basis or two bases depending on a location of the dropout coupler.

In some instances, systems and methods according to some aspects of the present disclosure can provide improved quantum error correction, such as a reduced logical error rate for a given physical error rate compared to some alternative implementations. For example, increased effective size (e.g., number of qubits, error correction code distance) of quantum hardware used to encode a logical qubit state can reduce a logical error rate for a given physical error rate, particularly at low physical error rates. For example, in some simulations according to some aspects of the present disclosure, various quantum error correction codes were simulated in simulated quantum computing systems with various physical error rates. In the example simulations, quantum error correction codes according to some aspects of the present disclosure had logical error rates about three times lower than the best known alternative implementation at physical error rates (e.g., SI1000 error rates) near 10⁻⁴, and almost thirty thousand times lower than some other alternative implementations at physical error rates near 10⁻⁴.

As another example, some methods disclosed herein can have one or both of two key features that may improve over some alternative methods. Firstly, the holes that are cut around broken components can be much smaller than in some alternative methods since they exist in the mid-cycle state. This can mean that example methods do not have as many issues with nearby holes merging together, and also suffer less of a performance penalty from individual dropouts. Additionally, some example circuits described herein can make it very easy to trade qubit roles. In the case of a qubit being removed, nearby qubits end up doing double duty to still measure relevant Pauli operators, much like a Surface-13 construction. This can still have a penalty on performance, but can preserve spacelike distance in some instances.

With reference now to the Figures, example embodiments of the present disclosure will be discussed in further detail.

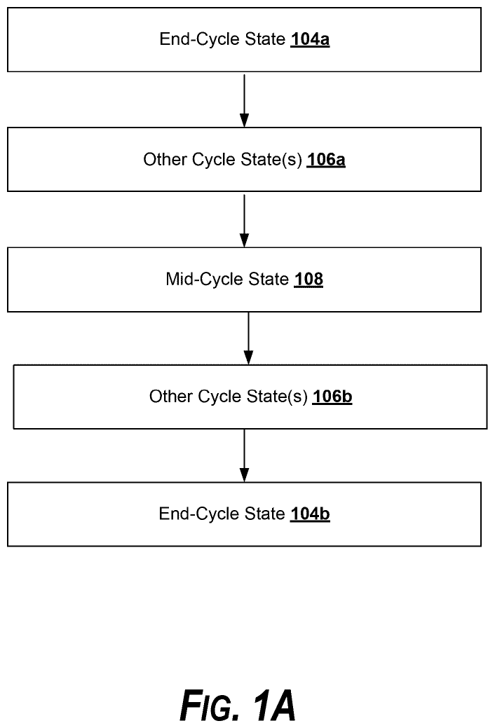

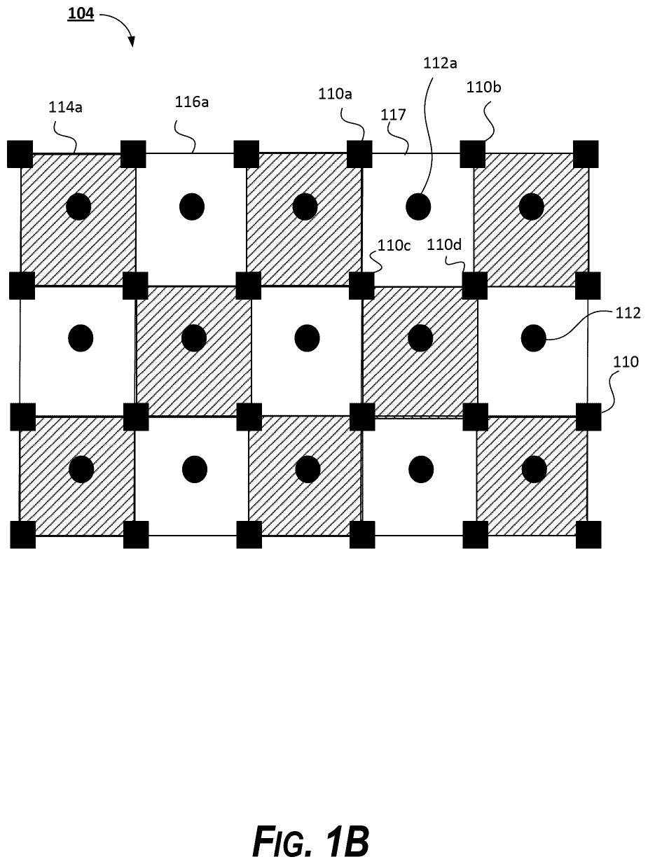

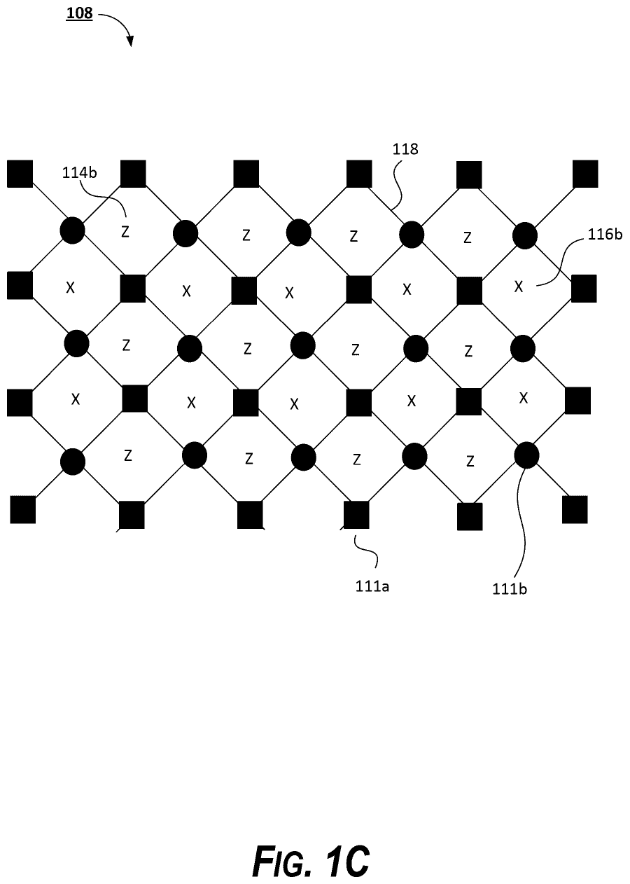

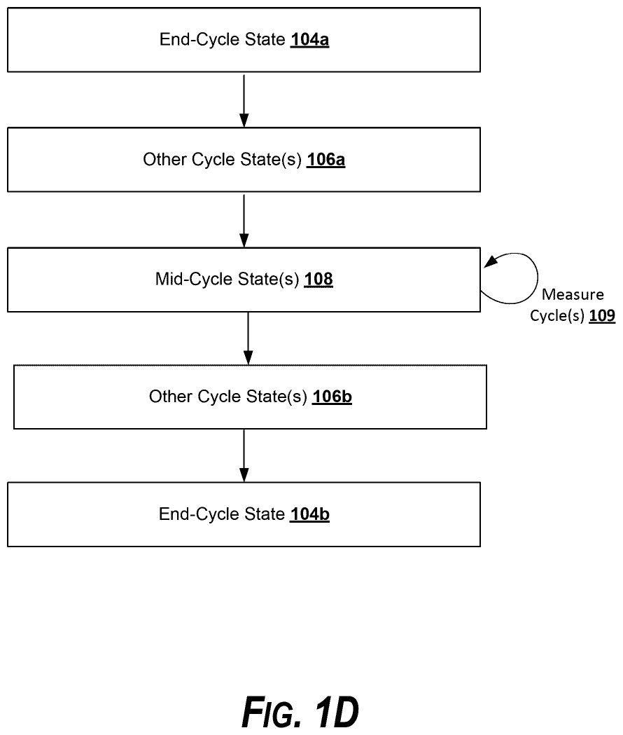

FIG. 1A depicts a block diagram of an example quantum error correcting cycle according to example implementations of some aspects of the present disclosure. At a beginning of a quantum error correcting cycle, a state of a quantum computing system can be a first end cycle state 104a. The quantum error correction cycle can include performing, by the quantum computing system, one or more first quantum computing operations (e.g., gating operations, readout operations, reset operations, etc.) such that the quantum computing system arrives at a mid-cycle state 108. At the mid-cycle state, the quantum error correction cycle can include performing one or more measurement operations, such as gauge operator measurements or stabilizer measurements. The quantum error correction cycle can further performing, by the quantum computing system, one or more second quantum computing operations (e.g., gating operations, readout operations, reset operations, etc.) such that the quantum computing system arrives at second end-cycle state 104b. In some instance, the quantum computing system can cycle through one or more other cycle states 106a, 106b, before or after the mid-cycle state 108.

An end-cycle state 104 can include, for example, any state of a quantum computing system that occurs at a beginning or end of a quantum error correction code cycle. For example, in some instances, an end-cycle state 104 can include a state at which one or more readout or reset operations are performed in a quantum error correction code (e.g., rotated quantum error correction code, etc.). For example, in some instances, an end-cycle state 104 can include a state corresponding to a rotated quantum error correction code state, such as an end state of a cycle of a rotated quantum error correction code cycle. In some instances, a first end-cycle state 104a can be a state at a beginning of a first quantum error correction code cycle, and a second end-cycle state 104b can be a state of the quantum computing system at the end of the first quantum error correction cycle. Further details of some example end-cycle states 104 are provided below with respect to FIG. 1B.

An other cycle state 106 can include, for example, a state of a quantum computing system (e.g., state of a quantum computing system during a quantum error correction cycle) that is not an end-cycle state 104 or a mid-cycle state 108. For example, in some instances, an other cycle state 106a can include a state that occurs before the mid-cycle state 108 in a quantum error correction cycle, such as a post-reset state (e.g., after a reset operation is performed to transition the quantum computing system from a first end-cycle state 104a to a post-reset state 106a, etc.), a brickwork state (e.g., after a brickwork operation is performed to transition the quantum computing system from a post-reset state 106a to a first brickwork state 106a, etc.). As another example, in some instances, an other cycle state 106b can include a state that occurs after the mid-cycle state 108 in a quantum error correction cycle, such as a brickwork state (e.g., after a brickwork operation is performed to transition the quantum computing system from a mid-cycle state 108 to a second brickwork state 106b, etc.) or a pre-measurement state (e.g., after one or more quantum gating operations are performed to transition the quantum computing system from a second brickwork state 106b to a pre-measurement state 106b; before one or more measurement operations are performed to transition the quantum computing system from a pre-measurement state 106b to a second end-cycle state 104b; etc.).

A mid-cycle state 108 can include, for example, a state of a quantum computing system at a midpoint of a quantum error correction cycle. In some instances, a mid-cycle state 108 can include a state associated with an unrotated error correction code, such as a state that corresponds to an unrotated version of a rotated error correction code associated with an end-cycle state 104. In some instances, a mid-cycle state 108 can include a state at which one or more stabilizers can be measured (e.g., without performing a reset operation, etc.), such as one or more first stabilizers that are different from one or more second stabilizers configured to be measured at an end-cycle state of the quantum computing system. For example, in some instances, a mid-cycle state 108 can include a state at which one or more zero-dropout local regions of the quantum computing system (i.e., local regions having no dropout devices) can be in a state for which one or more stabilizers (e.g., weight-4 stabilizers, four-qubit stabilizers, etc.) can be measured. Further details of an example mid-cycle state 108 corresponding to an example unrotated error correction code are provided below with respect to FIG. 1C. In some instances, a quantum error correction code can include measuring, at the mid-cycle state, one or more stabilizers or one or more gauge operators. In some instances, a quantum error correction code can include determining, at the mid-cycle state based on a plurality of gauge operators, one or more additional stabilizers. Further details of some example mid-cycle measurements and stabilizer determinations are provided below with respect to FIGS. 2A-11.

FIG. 1B depicts a schematic diagram of an example end-cycle state of an example quantum error correction cycle according to example implementations of some aspects of the present disclosure. A quantum computing system can include, for example, a plurality of qubits 110, 112 arranged in a grid pattern. For example, in some instances, a quantum computing system can include a plurality of qubits 110, 112 having designated roles as data qubits 110 and ancilla qubits 112, wherein each data qubit 110 is coupled to a plurality (e.g., four, three, etc.) of neighboring ancilla qubits 112 via one or more couplers (not expressly depicted in FIG. 1B; see FIG. 1C for example coupler depiction). An end-cycle state 104 can include, for example, a state in which a plurality of stabilizers can be measured, such as a plurality of Z stabilizers 114a and a plurality of X stabilizers 116a.

In the diagram of FIG. 1B, each data qubit 110 is represented as a small black square; each ancilla qubit is represented as a small black circle; each Z stabilizer 114a is represented as a larger square filled with a striped pattern; and each X stabilizer 116a is represented as an unfilled larger square. A stabilizer measurement can include, for example, a measurement of a quantum state associated with a plurality of qubits 110, 112 in a local region of the quantum computing system. As an illustrative example, a first X stabilizer 117 measurement can include a measurement of a quantum state associated with first, second, third and fourth data qubits 110a, 110b, 110c, 110d at the corners of the X stabilizer 117 local region depicted in FIG. 1B and associated with the first ancilla qubit 112a at the center of the X stabilizer 117 local region depicted in FIG. 1B. The same can be true, mutatis mutandis, for each depicted Z stabilizer 114a, X stabilizer 116a, and qubit 110, 112.

A data qubit 110 can include, for example, a qubit structure (e.g., qubit device, such as superconducting qubit, neutral atom qubit, or other qubit type, etc.) that is designated as a data qubit in a quantum error correction code.

An ancilla qubit 112 can include, for example, a qubit structure (e.g., qubit device, such as superconducting qubit, neutral atom qubit, or other qubit type, etc.) that is designated as an ancilla qubit (e.g., measurement qubit, auxiliary qubit, etc.) in a quantum error correction code (e.g., surface code, etc.) In some instances, an end-cycle state 104 can include a state in which a state of one or more ancilla qubits 112 corresponds to a state of one or more stabilizers 114a, 116a.

A Z stabilizer 114a can include, for example, a stabilizer in a Z basis (e.g., Pauli Z basis, etc.) that can be measured at an end-cycle state 104 of a quantum error correction code (e.g., surface code, etc.). An X stabilizer 116a can include, for example, a stabilizer in an X basis (e.g., Pauli X basis, etc.) that can be measured at an end-cycle state 104 of a quantum error correction code.

FIG. 1C depicts a schematic diagram of an example mid-cycle state of an example quantum error correction cycle according to example implementations of some aspects of the present disclosure. At the mid-cycle state 108, a plurality of qubits 111 can each be connected to one or more (e.g., four, three, etc.) neighboring qubits 111 via one or more couplers 118. A mid-cycle state 108 can include, for example, a state in which a plurality of Z stabilizers 114b and X stabilizers 116b can be measured.

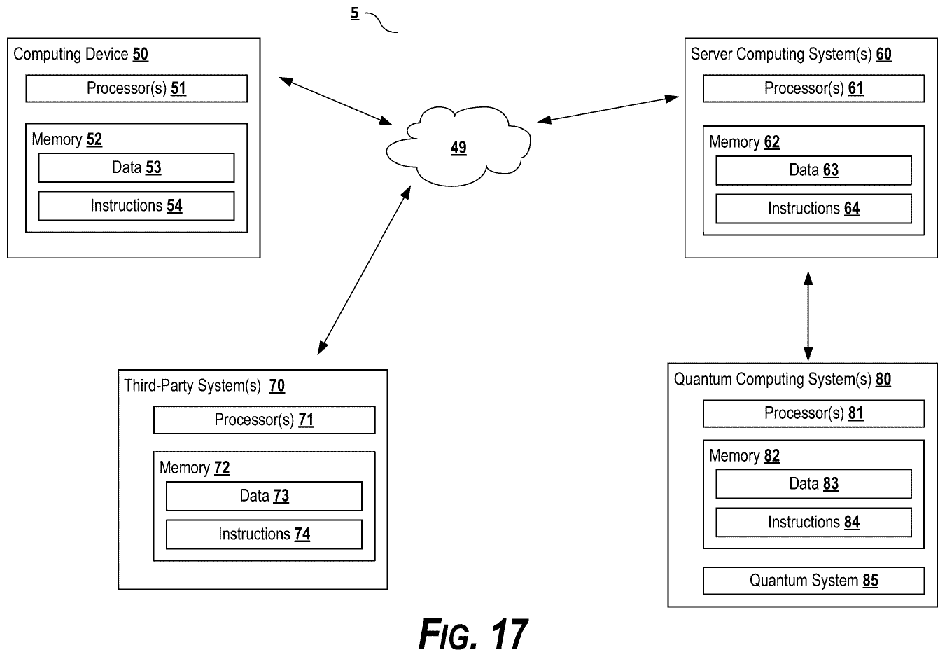

At the mid-cycle state 108, qubits 110, 112 that had designated roles as data qubits 110 and ancilla qubits 112 at an end-cycle state 104 may be viewed as equivalent qubits (e.g., effective data qubits, etc.), or as not having separate qubit roles (e.g., data qubit vs. measurement qubit roles, etc.) with respect to a mid-cycle state 108. For this reason, qubits 111a that were designated as data qubits 110 at an end-cycle state 104 and qubits 111b that were designated as ancilla qubits 112 at an end-cycle state 104 can in some instances be treated interchangeably. In the remainder of this disclosure, qubits 111 at a mid-cycle state may be described interchangeably, without regard to their role as data qubits 110 or ancilla qubits 112 at an end-cycle state 104. In other respects, a qubit 111 can have any property described herein with respect to a data qubit 110 or ancilla qubit 112, and vice versa. Similarly, a qubit 111 can have any property described below with respect to FIG. 16 and qubits 1626, 1628 or the like, and vice versa.

In the diagram of FIG. 1C, each Z stabilizer 114b is represented as a diamond with the letter Z inside, and each X stabilizer 116b is represented as a diamond shape having the letter X inside. A stabilizer measurement can include, for example, a measurement of a quantum state associated with a plurality of qubits 111 in a local region of the quantum computing system. For example, each X stabilizer 116b measurement can include a measurement (e.g., measurement in a Pauli X basis, etc.) of a quantum state of the four surrounding qubits 111 corresponding to the vertices of the depicted diamond shape. Similarly, each Z stabilizer 114b measurement can include a measurement (e.g., measurement in a Pauli Z basis, etc.) of a quantum state of the four surrounding qubits 111 corresponding to the vertices of the depicted diamond shape.

A coupler 118 can include, for example, a device for coupling a first qubit 111 to a second qubit 111; performing two-qubit quantum gates on the first qubit 111 and the second qubit 111; or the like. For example, in the diagram of FIG. 1B, each coupler 118 is depicted as a line, and each coupler 118 can couple a first qubit 111 at a first endpoint of the line to a second qubit 111 at a second endpoint of the line.

In some instances, the cycle states 104, 108 depicted in FIGS. 1B-1C can include time-like cross-sections of the detecting regions (e.g., detection regions 114a, 114b, 116a, 116b) of some example surface codes (e.g., surface code associated with a quantum computing system without dropout devices or local quantum computing system region without dropout devices, etc.). In the bulk rounds of some circuits, detecting regions can survive for two rounds, starting at measure qubit initialization, expanding into the full stabilizer in the first round of entangling gates, and then contracting back to be terminated in the second round. Detectors can be formed by combining all the measurements that a given detecting region terminates on, which for the regular circuit can be simply a comparison of subsequent measurements on the relevant measure qubit. This may not be the case for some example circuits according to aspects of the present disclosure, and consequently the detecting region picture can be particularly important when building the detectors for some example circuits according to aspects of the present disclosure.

Further details of some example detectors and methods for building detectors for some example quantum error correction circuits are described below with respect to FIG. 10.

In some instances, a mid-cycle state 108 of a standard surface code state can be an unrotated surface code state on both measure and data qubits. Based on this fact, some example quantum error correction circuits described herein can include novel surface code circuits constructed by measuring the mid-cycle stabilizers and then returning to the same state. In this view, some example circuits described herein can be constructed from mid-cycle state to mid-cycle state, with half-rounds at the beginning and end of the circuit to get to the usual initial and final states of a surface code circuit.

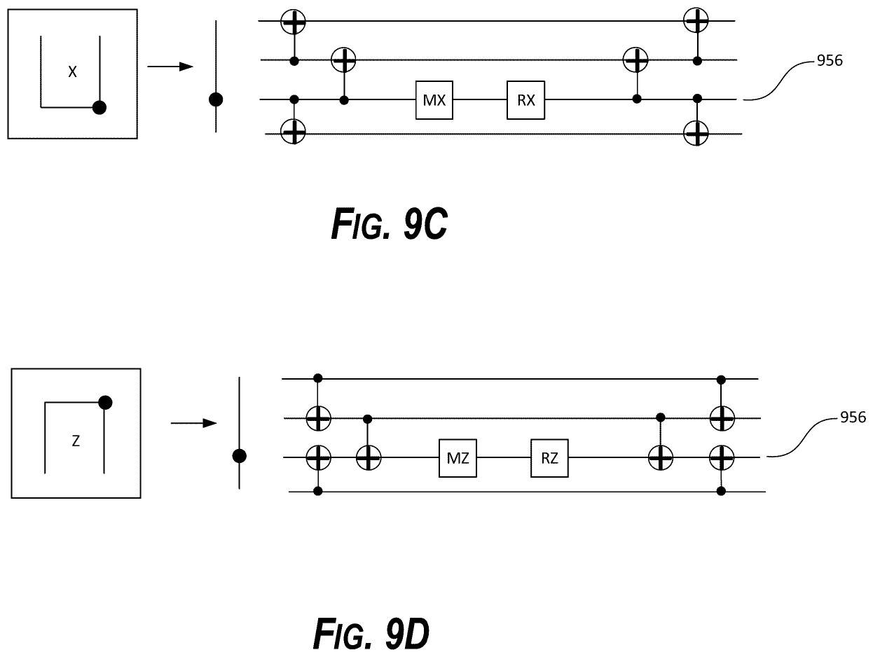

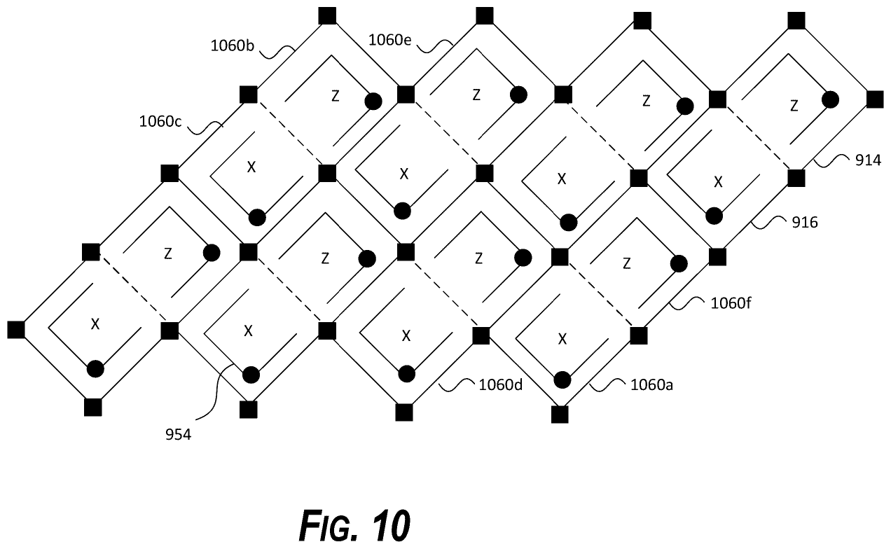

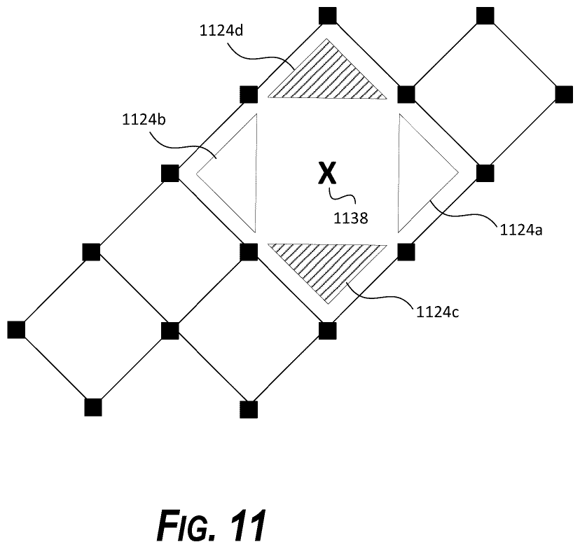

FIG. 1D depicts a block diagram of an example quantum error correcting cycle according to example implementations of some aspects of the present disclosure. The example quantum error correction cycle can include, for example, one or more end-cycle states 104; one or more mid-cycle states 108; and one or more other states 106. The example quantum error correction cycle can further include, for example, a plurality of measurement cycles 109 at a mid-cycle state 108 of a quantum computing error correction cycle. In some instances, each measurement cycle 109 can include performing, for each mid-cycle detecting region 114b, 116b of a plurality of mid-cycle detecting regions 114b, 116b, one or more quantum gating operations to fold a state of the mid-cycle detecting region 114b, 116b into a state of a qubit of the mid-cycle detecting region 114b, 116b. In some instances, each measurement cycle 109 can include measuring a state of each of a plurality of mid-cycle detection regions 114b, 116b. In some instances, each measurement cycle 109 can include performing one or more reset operations. In some instances, each measurement cycle 109 can include performing a plurality of quantum gating operations to return to a mid-cycle state 108, such as a second plurality of quantum gating operations that are an inverse of a first plurality of quantum gating operations used to fold a state of the mid-cycle detecting region 114b, 116b into a state of a qubit of the mid-cycle detecting region 114b, 116b. Further details of an example measurement cycle are provided below with respect to FIGS. 9C-10.

FIG. 2A depicts a schematic diagram of an example quantum computing system comprising two adjacent dropout couplers according to example implementations of some aspects of the present disclosure. A first dropout coupler 220a and a second dropout coupler 220b can each be coupled to a first qubit 111a. The first dropout coupler 220a and second dropout coupler 220b can be, for example, couplers 220a, 220b associated with a single detection region 114b, 116b of a mid-cycle state 108 of a quantum error correction code (e.g., surface code, etc.), such as a detection region associated with the first qubit 111a, along with second, third, and fourth qubits 111b, c, d.

A dropout coupler 220 can include, for example, a coupler that is not being used in a quantum computation; a coupler that is not being used in a current error correction cycle of a quantum error correction code; or the like. For example, in some instances, a dropout coupler 220 can include a coupler device that is permanently or temporarily unsuitable for use in a quantum computation. In some instances, a device that is unsuitable for use can include a device that is completely non-operational, or a device having a metric of suitability that does not meet a suitability threshold. For example, in some instances, an unsuitable coupler device can include a coupler device associated with an error rate metric (e.g., fidelity metric, qubit decoherence metric, T1 relaxation time, T2 dephasing time metric, etc.) or other performance metric (e.g., coupling strength metric, gating speed metric, etc.) that does not satisfy a predetermined performance threshold. In some instances, a dropout device can include a device that does not exist at all. For example, in some instances, a quantum computing system can include a quantum computing system that is intentionally or unintentionally manufactured without one or more couplers 220a, 220b between adjacent qubits without deviating from the scope of the present disclosure. In some instances, the quantum error correction methods described herein (e.g., in FIGS. 2B-2D) can be performed on any local region of a quantum computing system having the same local topology, irrespective of whether a dropout coupler 220 is missing, non-operational, or merely unused due to one or more unsuitable performance metrics.

As a non-limiting illustrative example, some QCS architectures have tunable couplers, which are essentially additional qubits that modulate the interactions between adjacent qubits. If these are damaged in fabrication the entangling operations mediated by the coupler might be appreciably higher in error, or not available at all. The case where a qubit or coupler is damaged such that it still works, but has a higher error rate, is known as a soft failure, while the case where the qubit or coupler is simply unavailable is referred to as a hard failure. Soft failures may also be caused by two-level systems (TLSs) in the device. These are unwanted quantum degrees of freedom which interact with the qubits and couplers, and an unluckily placed TLS can dramatically reduce the T1 and gate errors near it via unwanted swapping. Other examples are possible.

FIG. 2B depicts a schematic diagram of a plurality of example gauge operators and stabilizers for performing quantum error correction in an example quantum computing system comprising two adjacent dropout couplers 220 (e.g., faulty couplers, broken couplers, couplers associated with an error rate metric that is worse than an error rate threshold, etc.) according to example implementations of some aspects of the present disclosure. A quantum error correction operation can include measuring, at a mid-cycle state 108 of a quantum error correction code (e.g., surface code, subsystem code, etc.), a weight-1 (e.g., one-qubit, etc.) gauge operator 222 associated with the first qubit 111a that is coupled to both dropout couplers 220a, 220b. The quantum error correction operation can further include measuring, at the mid-cycle state 108 of a quantum error correction code (e.g., surface code, subsystem code, etc.), a weight-3 (e.g., three-qubit, etc.) gauge operator 224 associated with a second, third, and fourth qubit 111b, 111c, 111d associated with a first local detection region 226a that is associated with both dropout couplers 220a, 220b (e.g., local detection region 226a associated with a set of qubit structures 111 comprising one or more neighboring qubit structures 111b, 111d that are adjacent to the first qubit structure 111a, etc.). The quantum error correction operation can further include measuring, at the mid-cycle state 108 of a quantum error correction code (e.g., surface code, subsystem code, etc.), two weight-4 (e.g., four-qubit, square, etc.) gauge operators 228 associated with local detection region 226b, 226c that are each associated with one dropout coupler 220a or 220b. The quantum error correction can further include measuring, at the mid-cycle state 108 of the quantum error correction code, a weight-4 (e.g., four-qubit, square, etc.) stabilizer 230 associated with a fourth local detection region 226d that is not adjacent to either dropout coupler 220. In some instances, a quantum error correction operation can further include performing additional operations described below with respect to FIGS. 2C-2D.

In FIG. 2B and other figures herein, gauge operators and stabilizers associated with opposite measurement bases (e.g., X basis, Z basis, etc.; opposite Pauli type, etc.) are depicted with different patterns (e.g., striped pattern for weight-4 gauge operators 228a, 228b; blank pattern for weight-4 stabilizer 230 and gauge operators 222, 224; etc.). For example, in some instances, each of the weight-4 gauge operators 228a, 228b can be gauge operators measured in a Z basis, while each of the weight-4 stabilizer 230 and gauge operators 222, 224 can be measured in an X basis. As another example, in some instances, each of the weight-4 gauge operators 228a, 228b can be gauge operators measured in an X basis, while each of the weight-4 stabilizer 230 and gauge operators 222, 224 can be measured in a Z basis.

In some instances, the operations depicted in FIG. 2B and any other figure depicted herein can be applied to any rotational orientation of a set of dropout devices (e.g., dropout couplers 220, etc.) in a local region of the quantum computing system. For example, in FIG. 2B, the first detecting region 226a, along with the dropout couplers 220 associated with the first qubit 111a and first detection region 226a, can be located in any direction relative to the first qubit (e.g., above, below, or to the left of the first qubit as depicted in FIG. 2B, etc.). Continuing the example, the weight-4 stabilizer 230 can be associated with a detecting region opposite the first detection region 226a relative to the first qubit 111a; the weight-4 gauge operators 228 can be associated with detecting regions adjacent to the first detection region 226a (e.g., oriented at a 90-degree angle to the first detection region 226 a relative to the first qubit 111a, etc.); and the gauge operators 222, 224 can measure the first detection region 226a, regardless of a spatial orientation of the first detection region 226a and dropout couplers 220 relative to the first qubit 111a associated with both dropout couplers 220a, 220b.

As used herein, the term stabilizer can refer to a measured value that commutes with every other stabilizer of a quantum error correction code (e.g., stabilizer code, surface code, subsystem code, etc.). As used herein, the term gauge operator can refer to one or more values that may not commute with one or more other gauge operators or stabilizers. In some instances, a gauge operator can include a quantum operator that functions as a “piece” of a stabilizer, such as a value that can be combined (e.g., according to a tensor product operation, etc.) with one or more other gauge operators (e.g., gauge operators associated with a same detecting region at a mid-cycle state 108 of a quantum error correction code, etc.) to generate a stabilizer (e.g., stabilizer that commutes with every other stabilizer of a quantum error correction code). In some instances, a gauge operator can include, for example, a logical operator associated with a gauge qubit (e.g., qubit having a value that is not included or considered in a quantum error correction code; qubit associated with one or more spare degrees of freedom; etc.). For example, a gauge operator measurement can include a measurement that depends at least in part on a quantum state of a gauge qubit. In some instances, measurements of gauge operators (which can be implemented with circuits in a similar way as stabilizer measurements) can be individually random even when no error occurs. This can mean, for example, that comparing two consecutive measurements of the same gauge operator cannot reliably detect errors. However, detectors can be formed by combinations of measurements across multiple gauge operators, such that they can act as “pieces” of stabilizers.

In FIG. 2B and other figures herein, each depicted stabilizer and gauge operator is represented as a shape (e.g., polygon, ellipse, etc.) that “touches” each qubit that is associated with (e.g., measured by, etc.) the gauge operator or stabilizer. For example, the weight-1 gauge operator 222 is a measurement associated with only the first qubit 111a, and is depicted as an ellipse that touches only the first qubit 111a. Similarly, the weight-3 gauge operator 224 is a measurement of second, third, and fourth qubits 111b, c, d and is depicted as a triangle that touches each of the second, third, and fourth qubits 111b, c, d. Similarly, the weight-4 gauge operators 228a, b and weight-4 stabilizer 230 are depicted as squares that touch each of the four qubits 111 of a respective detection region 226c, 226b, 226d associated with the respective weight-4 measurements 228, 230. The same drawing convention is used throughout this disclosure.

Although both the weight-4 stabilizer 230 and weight-4 gauge operators 228 can be weight-4 measurements performed in a similar (e.g., same, same except in opposite X/Z bases, etc.) manner, the weight-4 gauge operators 228 can be considered gauge operators as they may not commute with every stabilizer of a quantum error correction code of FIG. 2B. For example, in instances where a weight-1 gauge operator associated with a first qubit 111a is measured in a first basis (e.g., X basis, Z basis), weight-4 measurements of the first qubit 111a in an opposite X/Z basis may not commute with a stabilizer generated from the weight-1 gauge operator, whereas weight-4 measurements in the first basis involving the first qubit 111a may in some instances be stabilizers.

FIG. 2C depicts a schematic diagram of an example method for combining gauge operators to generate a stabilizer for an example quantum computing system comprising two adjacent dropout couplers according to example implementations of some aspects of the present disclosure. A quantum error correction operation can include, for example, combining a weight-1 gauge operator 222 associated with a first qubit 111a of a first local detection region 226a with a weight-3 gauge operator 224 associated with a second, third, and fourth qubit 111b, c, d of the first local detection region 226a to generate a four-qubit stabilizer 232 measurement associated with the first local detection region 226a.

In some instances, combining a plurality of gauge operators can include, for example, determining a tensor product of the gauge operators. In some instances, combining a plurality of gauge operators to generate a stabilizer can include, for example, combining such that one or more components (e.g., measurement components, quantum state components, etc.) of each of the plurality of gauge operators is canceled out. In some instances, combining a plurality of gauge operators to generate a stabilizer can include combining such that one or more excess degrees of freedom are canceled out. In some instances, combining gauge operators can include combining adjacent gauge operators.

FIG. 2D depicts a schematic diagram of an example method for combining gauge operators to generate a stabilizer for an example quantum computing system comprising two adjacent dropout couplers according to example implementations of some aspects of the present disclosure. A first weight-4 gauge operator 228a associated with a first local detection region 226c can be combined with a second weight-4 gauge operator 228b associated with a second local detection region 226b that shares a first qubit 111a with the first detection region 226c to generate a weight-6 gauge operator 234 associated with three qubits 111b, 111h, 111i of the first local detection region 226c and three qubits 111d, 111e, 111f of the second detection region 226b.

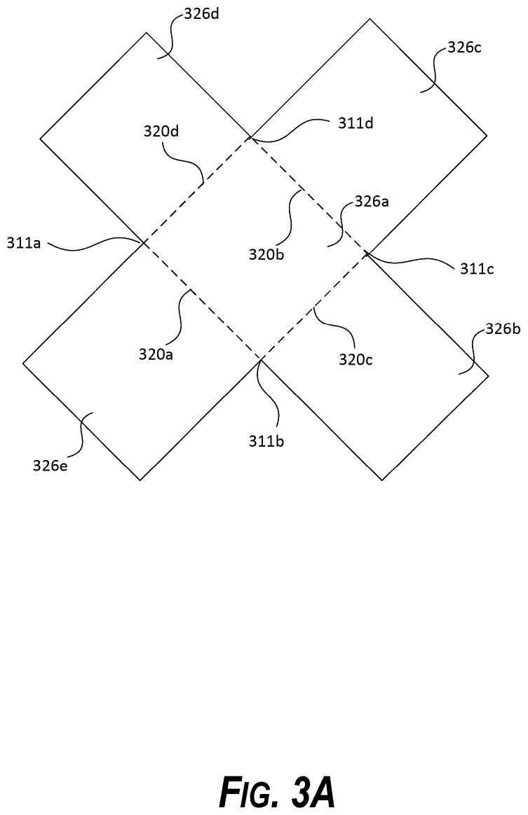

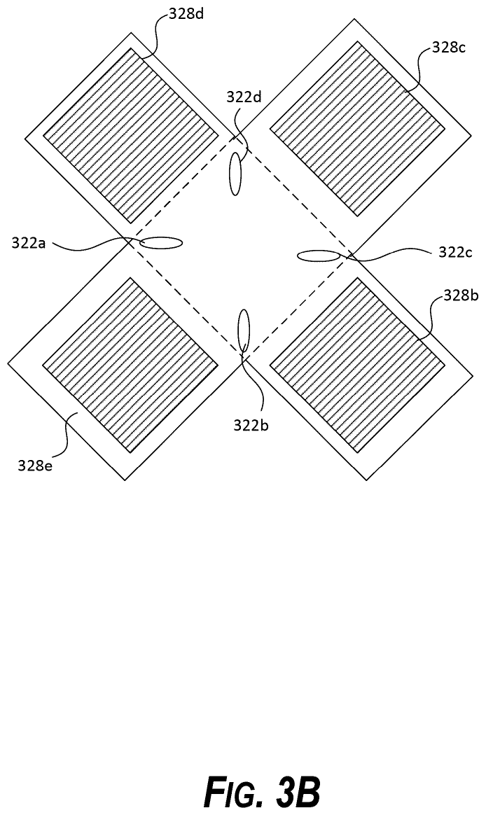

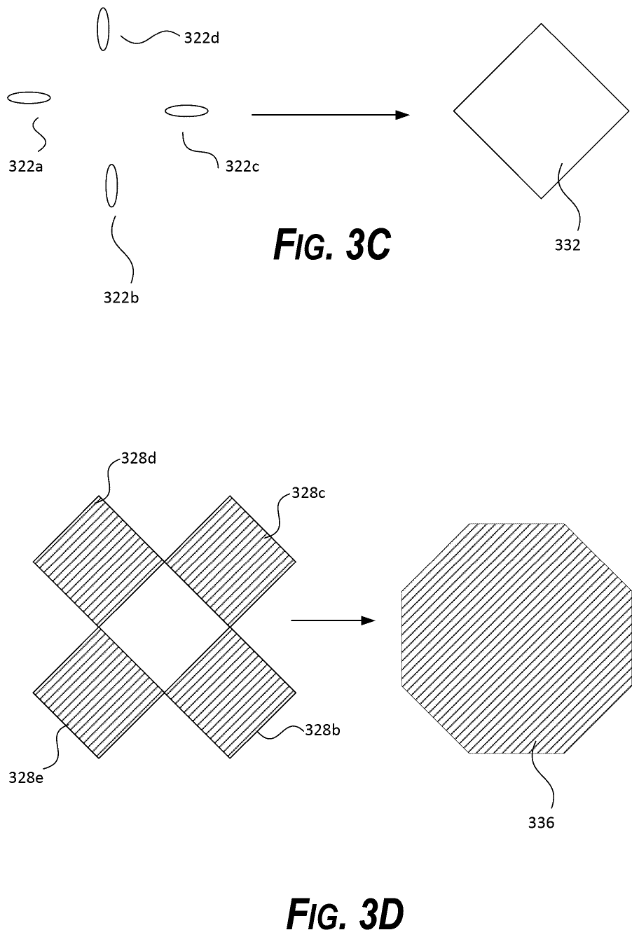

In some instances, generating a stabilizer from two or more gauge operators 228 can include, for example, combining (e.g., determining a tensor product, etc.) the gauge operators 228 in a manner that cancels out one or more measurement components associated with one or more gauge qubits. For example, in FIGS. 2B and 2D, the weight-4 gauge operators 228 can each be associated with the first qubit 111a, and can each be measured in an opposite X/Z basis compared to the single-qubit gauge operator 222 associated with the first qubit 111a. Continuing the example, the weight-4 gauge operators 228 can be combined such that a first first-qubit 111a component of the first weight-4 gauge operator 228a can cancel out a second first-qubit 111a component of the second weight-4 gauge operator 228b, thereby forming a weight-6 stabilizer associated with each qubit of the weight-4 gauge operators 228a, 228b other than the first qubit 111a. Similar operations combining gauge operators to cancel out measurement components associated with gauge qubits can be performed for other dropout device configurations, such as dropout device configurations illustrated herein with respect to FIGS. 3A-11 or dropout device configurations not expressly illustrated herein.

In some instances, each mid-cycle stabilizer 230, 232, 234 determined according to methods described herein with respect to FIGS. 2B-2D can commute with a plurality of other mid-cycle stabilizers associated with a plurality of other local regions of a quantum computing system, such as a plurality of mid-cycle stabilizers 114b, 116b associated with local detection regions having no dropout devices; a plurality of mid-cycle stabilizers associated with local regions having one or more dropout devices (e.g., stabilizers determined according to methods described herein with respect to FIGS. 3A-11, etc.); or some combination thereof.

In some instances, a quantum error correction code implemented according to aspects of FIGS. 2B-2D can have a distance that is reduced by one in a first basis (e.g., Z basis, etc.) and unchanged in a second basis (e.g., X basis, etc.) compared to a corresponding quantum error correction code without one or more dropout couplers 220, which can be a smaller reduction in distance than some alternative implementations.

FIG. 3A depicts a schematic diagram of an example quantum computing system comprising four dropout couplers in a square formation according to example implementations of some aspects of the present disclosure. A quantum computing system can include a plurality of dropout couplers 320a, 320b, 320c, 320d associated with a single local detection region 326a.

In some instances, a qubit 311, dropout coupler 320, or detection region 326 can be, comprise, be comprised by, or otherwise share one or more properties with a qubit 111, dropout coupler 220, or detection region 226. For example, in some instances, a qubit 311, dropout coupler 320, or detection region 326 can have any property described herein with respect to a qubit 111, dropout coupler 220, or detection region 226, and vice versa. More generally, any component described herein can have any property described herein with respect to another component having a similar (e.g., same, etc.) name or part number.

FIG. 3B depicts a schematic diagram of a plurality of example gauge operators and stabilizers for performing quantum error correction in an example quantum computing system comprising four dropout couplers in a square formation according to example implementations of some aspects of the present disclosure.

A quantum error correction operation can include measuring, at a mid-cycle state 108 of a quantum error correction code (e.g., surface code, subsystem code, etc.), a plurality of weight-1 gauge operators 322a, 322b, 322c, 322d associated with a plurality of corresponding qubits 311a, 311b, 311c, 311d of a local detection region 326a associated with all four of the dropout couplers 320a, 320b, 320c, 320d. The quantum error correction operation can further include measuring, at a mid-cycle state 108 of a quantum error correction code (e.g., surface code, subsystem code, etc.), a plurality of weight-4 gauge operators 328b, 328c, 328d, 328e associated with a plurality of local detection regions 326b, 326c, 326d, 326e each associated with one or more of the dropout couplers 320a, 320b, 320c, 320d.

FIG. 3C depicts a schematic diagram of an example method for combining gauge operators to generate a stabilizer for an example quantum computing system comprising four dropout couplers in a square formation according to example implementations of some aspects of the present disclosure.

A quantum error correction operation can include, for example, combining a plurality of weight-1 gauge operators 322a, b, c, d associated with a local detection region 326 associated with the four dropout couplers 320a, b, c, d to generate a weight-4 stabilizer 332 associated with the local detection region 326a associated with the four dropout couplers 320a, b, c, d.

FIG. 3D depicts a schematic diagram of an example method for combining gauge operators to generate a stabilizer for an example quantum computing system comprising four dropout couplers in a square formation according to example implementations of some aspects of the present disclosure.

A quantum error correction operation can include, for example, combining a plurality of weight-4 gauge operators 328b, c, d, e associated with a plurality of respective local detection regions 326b, c, d, e each associated with one or more of the dropout couplers 320a, b, c, d to generate a weight-8 (e.g., eight-qubit, etc.) stabilizer 336 associated with each qubit 111 that adjoins exactly one local detection region 326 of the plurality of local detection regions 326b, c, d, e that are associated with the dropout couplers 320a, b, c, d. In other words, the weight-8 stabilizer 336 can be associated with each qubit 111 that adjoins one of the local detection regions 326b, 326c, 326d, 326e but is not coupled to a dropout coupler 320a, b, c, d.

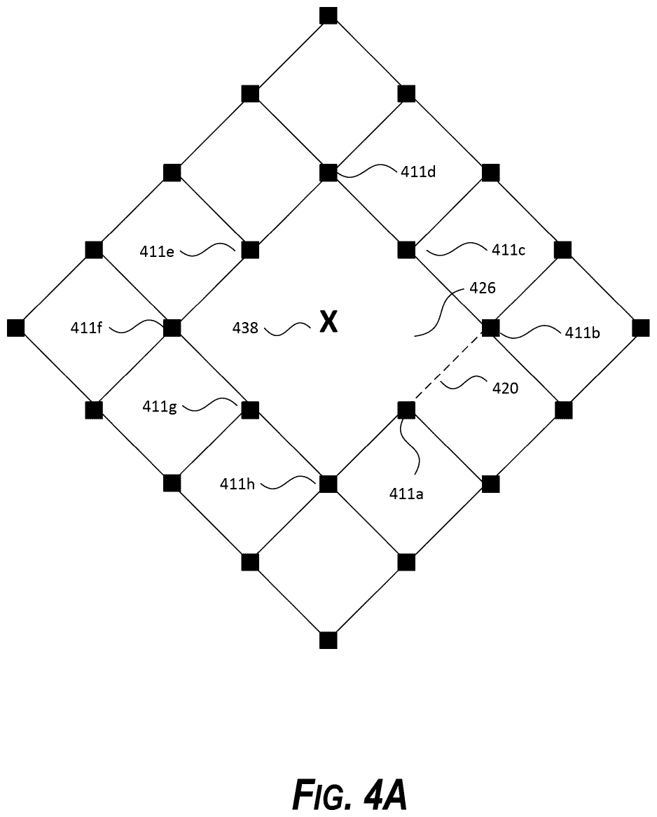

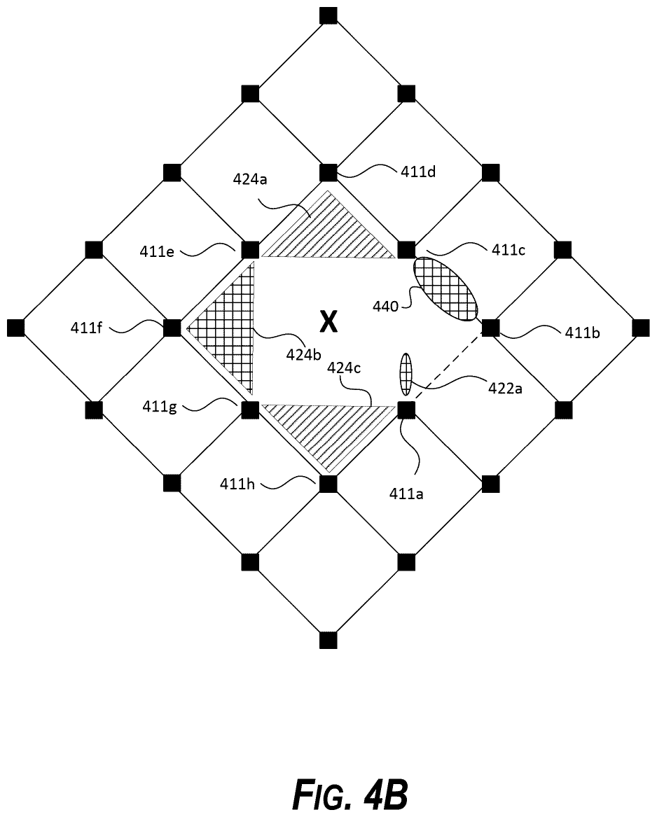

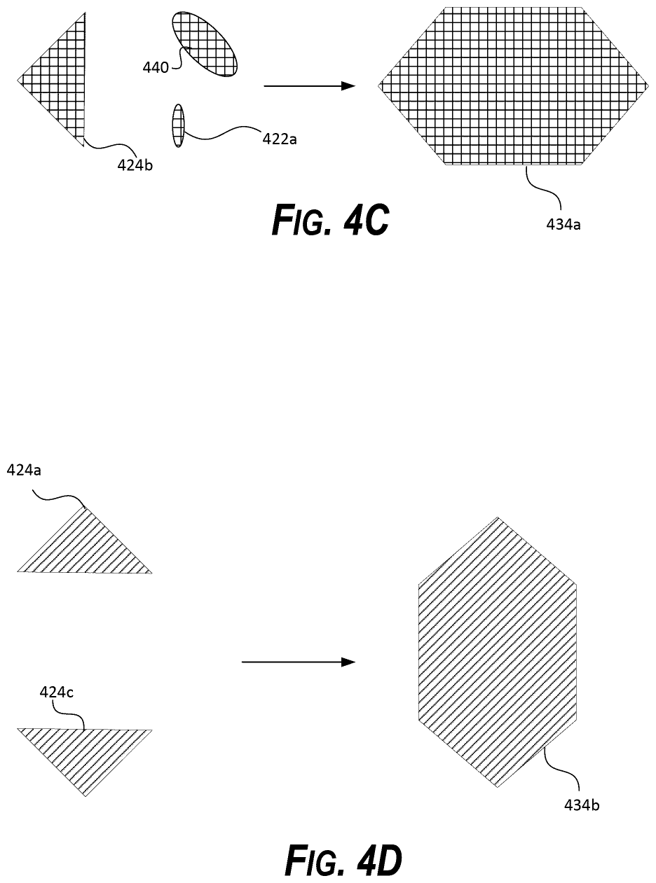

FIG. 4A depicts a schematic diagram of an example quantum computing system comprising a dropout qubit structure adjacent to a dropout coupler according to example implementations of some aspects of the present disclosure. A quantum computing system can include a dropout qubit 438 and a dropout coupler 420 that is adjacent to a local detection region 426a associated with the dropout qubit 438 (e.g., a dropout coupler 420 that is adjacent to a qubit 411a that is adjacent to the dropout qubit 438 in a square grid of qubits 111).

FIG. 4B depicts a schematic diagram of a plurality of example gauge operators and stabilizers for performing quantum error correction in an example quantum computing system comprising a dropout qubit structure adjacent to a dropout coupler according to example implementations of some aspects of the present disclosure. A quantum error correction operation can include measuring, at a mid-cycle state 108 of a quantum error correction code (e.g., surface code, subsystem code, etc.), a weight-1 (e.g., single-qubit, etc.) gauge operator 422a associated with a qubit 411a that is adjacent to both the dropout qubit 438 and the dropout coupler 420. The quantum error correction operation can further include measuring, at a mid-cycle state 108 of the quantum error correction code (e.g., surface code, subsystem code, etc.), a two-qubit gauge operator (e.g., weight-2 gauge operator, multi-qubit gauge operator, etc.) associated with a second qubit 411b that is adjacent to the dropout coupler 420 and a third qubit 411c that is adjacent to the dropout qubit 438. The quantum error correction operation can further include measuring, at a mid-cycle state 108 of the quantum error correction code (e.g., surface code, subsystem code, etc.), a weight-3 (e.g., three-qubit, etc.) gauge operator 424a associated with fourth and fifth qubits 411c, 411e that are adjacent to the dropout qubit 438 and a sixth qubit 411d that is adjacent to the fourth and fifth qubits 411c, e. The quantum error correction operation can further include measuring, at a mid-cycle state 108 of the quantum error correction code (e.g., surface code, subsystem code, etc.), a weight-3 gauge operator 424b (e.g., three-qubit gauge operator, multi-qubit gauge operator, etc.) associated with fifth and seventh qubits 411e, g that are adjacent to the dropout qubit 438 and an eighth qubit 411f that is adjacent to the fifth and seventh qubits 411e, g. The quantum error correction operation can further include measuring, at a mid-cycle state 108 of the quantum error correction code (e.g., surface code, subsystem code, etc.), a weight-3 (e.g., three-qubit, etc.) gauge operator 424c associated with seventh and first qubits 411g, 411a that are adjacent to the dropout qubit in a topological qubit grid (e.g., square grid, etc.) of the quantum computing system, and an eighth qubit 411h that is adjacent to the seventh and first qubits 411g, 411a.

In some instances, dropout qubit structures can include one or more of: faulty qubit structures, qubit structures having an error rate metric that is worse than an error rate threshold (e.g., T1 relaxation time metric, T2 dephasing time metric, fidelity metric, error detection event fraction of a quantum error correction code, etc.), qubit structures that are not currently in use for any reason, broken qubits, missing qubit devices, or other dropout qubit structures.

FIG. 4C depicts a schematic diagram of an example method for combining gauge operators to generate a stabilizer for an example quantum computing system comprising a dropout qubit structure adjacent to a dropout coupler according to example implementations of some aspects of the present disclosure. A quantum error correction operation can include, for example, combining a weight-1 gauge operator 422a, a weight-2 gauge operator 440, and a weight-3 gauge operator 424b to generate a weight-6 stabilizer 434a associated with qubits 411a, 411b, 411c, 411e, 411f, and 411g.

FIG. 4D depicts a schematic diagram of an example method for combining gauge operators to generate a stabilizer for an example quantum computing system comprising a dropout qubit structure adjacent to a dropout coupler according to example implementations of some aspects of the present disclosure. A quantum error correction operation can include, for example, combining a weight-3 gauge operator 424a with a weight-3 gauge operator 424c to generate a weight-6 stabilizer 434 b associated with qubits 411a, c, d, e, g, h.

FIG. 5A depicts a schematic diagram of a first view of an example quantum computing system comprising a hexagonal grid of qubits according to example implementations of some aspects of the present disclosure. Each qubit 111 in an interior of the hexagonal grid can be coupled to three neighboring qubits 111 via three couplers 118, although some edge qubits 111 near an edge of the hexagonal grid may be coupled to fewer than three qubits in some instances (or, in some instances, may be connected to three qubits according to a toroidal topology or the like).

FIG. 5B depicts a second schematic diagram of the example quantum computing system comprising the hexagonal grid of qubits of FIG. 5A. Each qubit 511 in an interior of the hexagonal grid can be coupled to three neighboring qubits 511 via three couplers 118. For ease of understanding a relationship between hexagonal grids wherein each qubit 511 is coupled to three couplers 118 and square grids wherein each qubit 511 is coupled to four adjacent couplers 118, FIG. 5B depicts the hexagonal grid as a topologically equivalent square grid having a plurality of omitted couplers 542 arranged such that each qubit 511 is coupled to three non-dropout couplers 118 and one omitted coupler 542. It will be appreciated that the hexagonal topological grid of FIG. 5B is topologically equivalent to the hexagonal topological grid of FIG. 5A. For example, as shown in FIG. 5B, a hexagonal grid can be topologically equivalent to a square grid in which a plurality of omitted couplers 542 are omitted from the square grid.

An omitted coupler 542 can include, for example, a dropout coupler 220 that is intentionally omitted from a quantum computing system (e.g., not added during a manufacturing process) that is manufactured to include a hexagonal grid of qubits (e.g., instead of a square grid of qubits, etc.); a dropout coupler 220 that is left unused to cause a quantum computing system to operate according to a hexagonal grid topology (e.g., despite the omitted coupler 542 being otherwise suitable for use in a quantum computing operation, etc.); or other dropout coupler 220. For example, in some instances, a quantum computing system comprising a hexagonal grid of qubits can lack any device or structure coupling non-adjacent qubits 511b, 511e of the hexagonal grid, and the dashed line depicting an omitted coupler 542 can correspond to no physical device or structure in a quantum computing system, but can be included in FIGS. 5B-9D for ease of understanding a relationship between quantum error correction codes for hexagonal grid topologies and similar quantum error correction codes for square grid topologies.

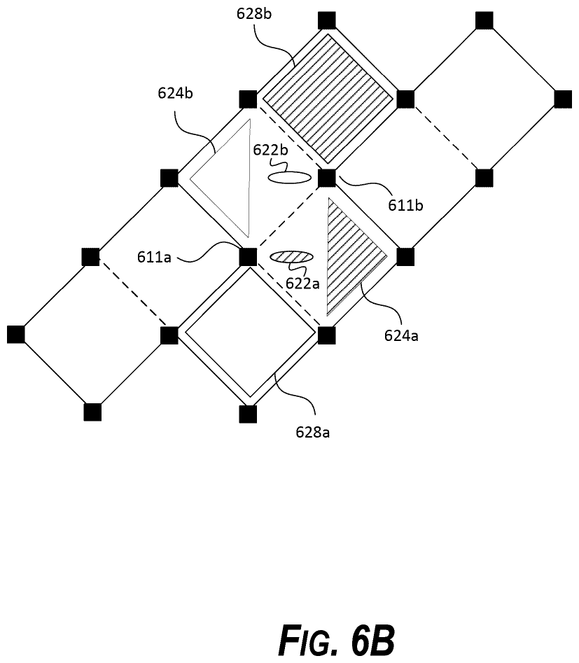

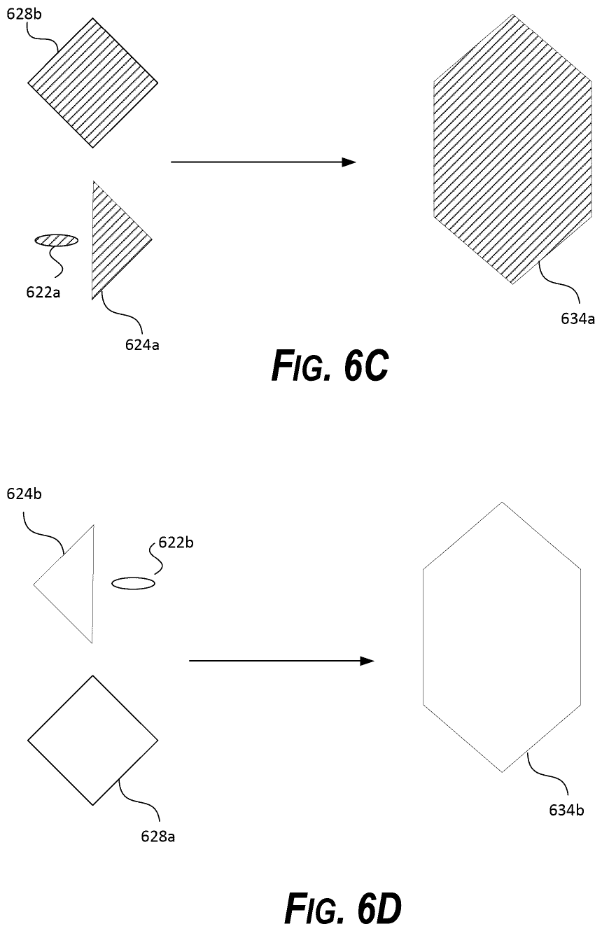

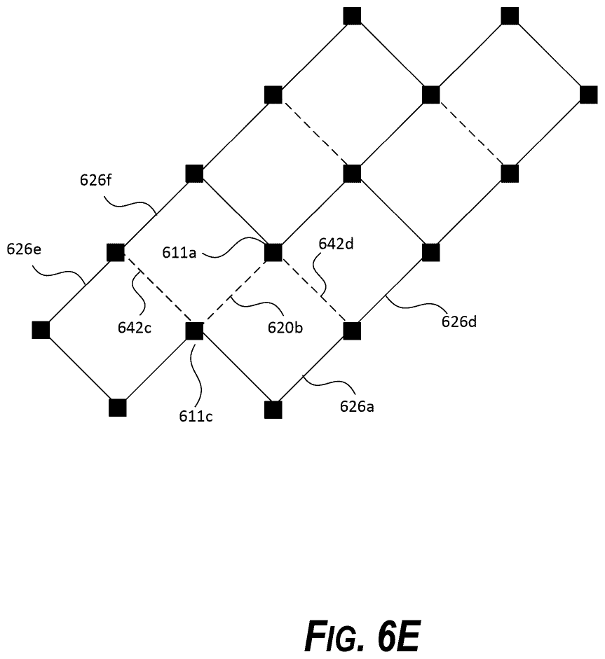

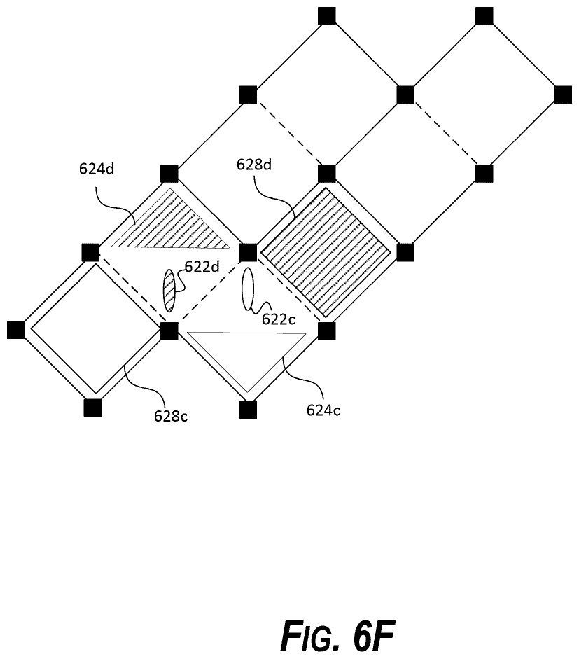

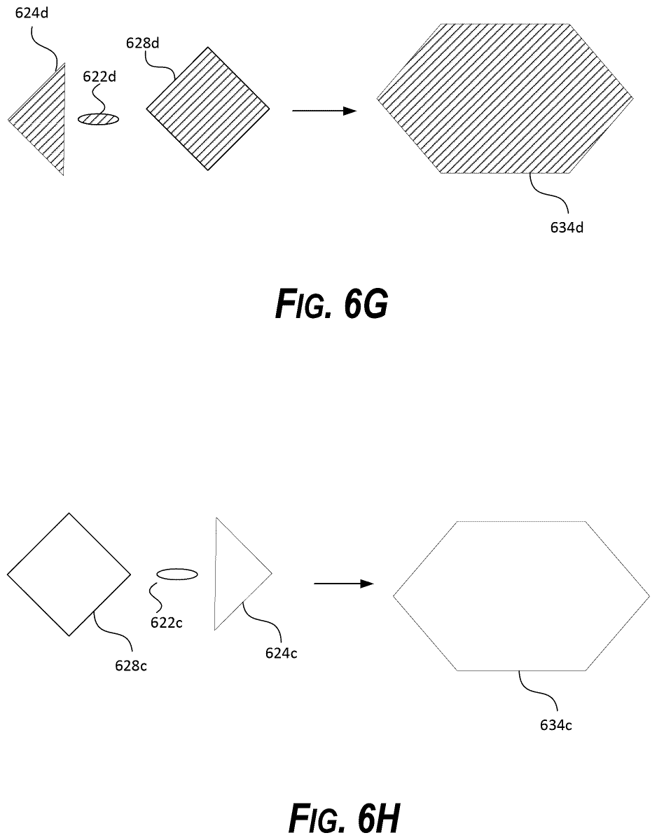

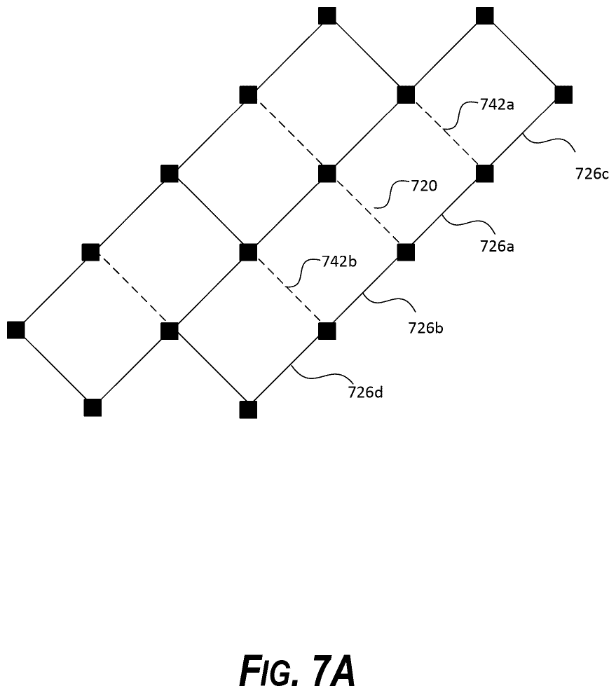

FIG. 6A depicts a schematic diagram of an example quantum computing system comprising a dropout coupler in a first location within a hexagonal grid of qubit structures according to example implementations of some aspects of the present disclosure. A dropout coupler 620 of a quantum computing system comprising a hexagonal grid can be adjacent to each of two omitted couplers 642 of the hexagonal grid. For example, the dropout coupler 620 can be adjacent to each of two omitted couplers 642 in a configuration that causes each of two local detection regions 626a, 626b to be adjacent to two dropout or omitted couplers 620, 642. In some instances, this configuration can be equivalent to the configuration depicted above in FIG. 2A, wherein each of two adjacent local detection regions 626a, 626b is adjacent to two dropout or omitted couplers 620, 642 as depicted in FIG. 2A.

FIG. 6B depicts a schematic diagram of a plurality of example gauge operators and stabilizers for performing quantum error correction in an example quantum computing system comprising a dropout coupler in a first location within a hexagonal grid of qubit structures according to example implementations of some aspects of the present disclosure.

A quantum error correction operation can include measuring, at a mid-cycle state 108 of a quantum error correction code (e.g., surface code, subsystem code, etc.), a weight-1 gauge operator 622a associated with a first qubit 611a associated with a first omitted coupler 642a and the dropout coupler 620. The quantum error correction operation can further include measuring, at a mid-cycle state 108 of a quantum error correction code (e.g., surface code, subsystem code, etc.), a weight-1 gauge operator 622b associated with a second qubit 611b associated with a second omitted coupler 642b and the dropout coupler 620. The quantum error correction operation can further include measuring, at a mid-cycle state 108 of a quantum error correction code (e.g., surface code, subsystem code, etc.), a first weight-4 gauge operator 628a (e.g., four-qubit gauge operator, multi-qubit gauge operator, etc.) associated with a first local detection region 626a adjacent to a first omitted coupler 642a. The quantum error correction operation can further include measuring, at a mid-cycle state 108 of a quantum error correction code (e.g., surface code, subsystem code, etc.), a second weight-4 gauge operator 628b associated with a second local detection region 626b adjacent to a second omitted coupler 642b. The quantum error correction operation can further include measuring, at a mid-cycle state 108 of a quantum error correction code (e.g., surface code, subsystem code, etc.), a three-qubit (weight-3) gauge operator associated with a third local detection region 626c adjacent to both the dropout coupler 620 and the second omitted coupler 642b. The quantum error correction operation can further include measuring, at a mid-cycle state 108 of a quantum error correction code (e.g., surface code, subsystem code, etc.), a three-qubit (weight-3) gauge operator associated with a fourth local detection region 626d adjacent to both the dropout coupler 620 and the first omitted coupler 642a (e.g., local detection region 626d associated with a set of qubit structures 111 comprising one or more neighboring qubit structures that are adjacent to the first qubit structure 611a, etc.).

FIG. 6C depicts a schematic diagram of an example method for combining gauge operators to generate a stabilizer for an example quantum computing system comprising a dropout coupler in a first location within a hexagonal grid of qubit structures according to example implementations of some aspects of the present disclosure.

A quantum error correction operation can include, for example, combining a first weight-1 gauge operator 622a, a first weight-three gauge operator 624a, and a second weight-4 gauge operator 628b to generate a weight-6 stabilizer 634a associated with each qubit 111 associated with the gauge operators 622a, 624a, 628b, except for the shared qubit 611a that is associated with both the weight-three gauge operator 624a and the weight-4 gauge operator 628b.

FIG. 6D depicts a schematic diagram of an example method for combining gauge operators to generate a stabilizer for an example quantum computing system comprising a dropout coupler in a first location within a hexagonal grid of qubit structures according to example implementations of some aspects of the present disclosure;

A quantum error correction operation can include, for example, combining a second weight-1 gauge operator 622b, a second weight-three gauge operator 624b, and a first weight-4 gauge operator 628a to generate a weight-6 stabilizer 634b associated with each qubit 111 associated with the gauge operators 622b, 624b, 628a, except for the shared qubit 611b that is associated with both the weight-three gauge operator 624b and the weight-4 gauge operator 628a.

In some instances, a quantum error correction code implemented according to aspects of FIGS. 6B-6D can have a distance that is reduced by one in a first basis (e.g., Z basis, etc.) and unchanged in a second basis (e.g., X basis, etc.) compared to a corresponding quantum error correction code without a dropout coupler 620, which can be a smaller reduction in distance than some alternative implementations.

FIG. 6E depicts a schematic diagram of an example quantum computing system comprising a dropout coupler in a second location within a hexagonal grid of qubit structures according to example implementations of some aspects of the present disclosure. A dropout coupler 620b of a quantum computing system comprising a hexagonal grid can be adjacent to each of two omitted couplers 642c, 642d of the hexagonal grid. For example, the dropout coupler 620b can be adjacent to each of two omitted couplers 642 in a configuration that causes each of two local detection regions 626a, 626f to be adjacent to two dropout or omitted couplers 620, 642. In some instances, this configuration can be equivalent to the configuration depicted above in FIG. 2A or FIG. 6A, wherein each of two adjacent local detection regions 626a, 626f is adjacent to two dropout or omitted couplers 620, 642 as depicted in FIG. 2A.

FIG. 6F depicts a schematic diagram of a plurality of example gauge operators and stabilizers for performing quantum error correction in an example quantum computing system comprising a dropout coupler in a second location within a hexagonal grid of qubit structures according to example implementations of some aspects of the present disclosure.

A quantum error correction operation can include measuring, at a mid-cycle state 108 of a quantum error correction code (e.g., surface code, subsystem code, etc.), a weight-1 gauge operator 622c associated with a first qubit 611a associated with a first omitted coupler 642d and the dropout coupler 620b. The quantum error correction operation can further include measuring, at a mid-cycle state 108 of a quantum error correction code (e.g., surface code, subsystem code, etc.), a weight-1 gauge operator 622d associated with a second qubit 611c associated with a second omitted coupler 642c and the dropout coupler 620b. The quantum error correction operation can further include measuring, at a mid-cycle state 108 of a quantum error correction code (e.g., surface code, subsystem code, etc.), a first weight-4 gauge operator 628c (e.g., four-qubit gauge operator, multi-qubit gauge operator, etc.) associated with a first local detection region 626e adjacent to a second omitted coupler 642c. The quantum error correction operation can further include measuring, at a mid-cycle state 108 of a quantum error correction code (e.g., surface code, subsystem code, etc.), a second weight-4 gauge operator 628d associated with a second local detection region 626d adjacent to a first omitted coupler 642d. The quantum error correction operation can further include measuring, at a mid-cycle state 108 of a quantum error correction code (e.g., surface code, subsystem code, etc.), a three-qubit (weight-3) gauge operator 624c associated with a third local detection region 626a adjacent to both the dropout coupler 620b and the first omitted coupler 642d. The quantum error correction operation can further include measuring, at a mid-cycle state 108 of a quantum error correction code (e.g., surface code, subsystem code, etc.), a three-qubit (weight-3) gauge operator 624d associated with a fourth local detection region 626f adjacent to both the dropout coupler 620b and the second omitted coupler 642c (e.g., local detection region 626d associated with a set of qubit structures 111 comprising one or more neighboring qubit structures that are adjacent to the qubit structure 611c associated with the weight-1 gauge operator 622d, etc.).

FIG. 6G depicts a schematic diagram of an example method for combining gauge operators to generate a stabilizer for an example quantum computing system comprising a dropout coupler in a second location within a hexagonal grid of qubit structures according to example implementations of some aspects of the present disclosure.

A quantum error correction operation can include, for example, combining a weight-1 gauge operator 622d, a weight-three gauge operator 624d, and a weight-4 gauge operator 628d to generate a weight-6 stabilizer 634d associated with each qubit 111 associated with the gauge operators 622d, 624d, 628d, except for the shared qubit 611a that is associated with both the weight-three gauge operator 624d and the weight-4 gauge operator 628d.

FIG. 6H depicts a schematic diagram of an example method for combining gauge operators to generate a stabilizer for an example quantum computing system comprising a dropout coupler in a second location within a hexagonal grid of qubit structures according to example implementations of some aspects of the present disclosure;

A quantum error correction operation can include, for example, combining a second weight-1 gauge operator 622c, a second weight-three gauge operator 624c, and a first weight-4 gauge operator 628c to generate a weight-6 stabilizer 634c associated with each qubit 111 associated with the gauge operators 622c, 624c, 628c, except for the shared qubit 611c that is associated with both the weight-three gauge operator 624c and the weight-4 gauge operator 628c.

In some instances, a quantum error correction code implemented according to aspects of FIGS. 6F-6H can have a distance that is reduced by one in a first basis (e.g., Z basis, etc.) and unchanged in a second basis (e.g., X basis, etc.) compared to a corresponding quantum error correction code without a dropout coupler 620, which can be a smaller reduction in distance than some alternative implementations.

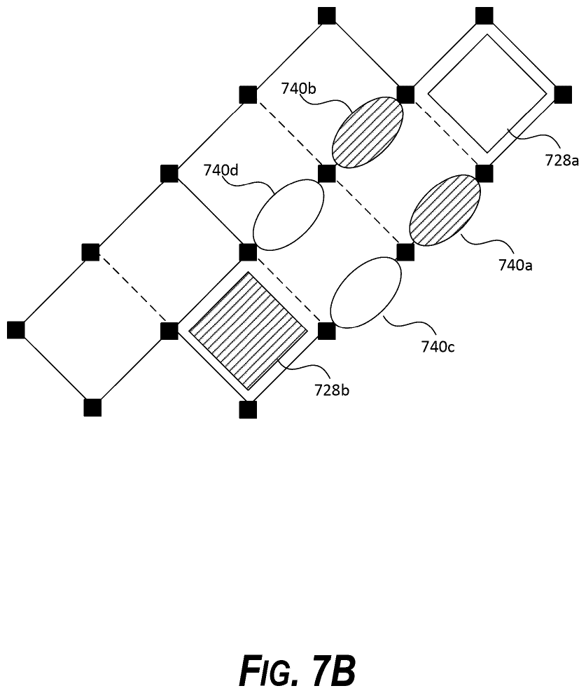

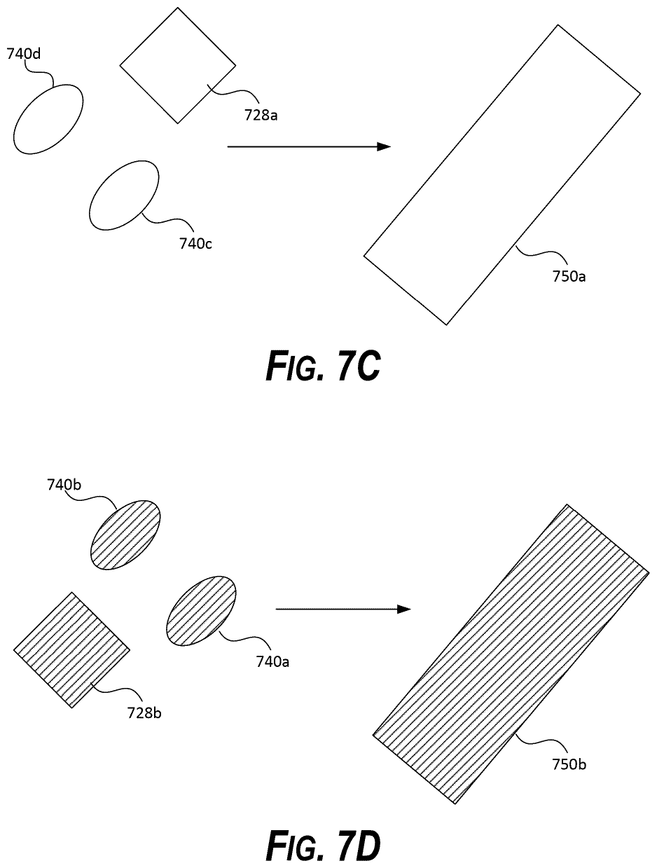

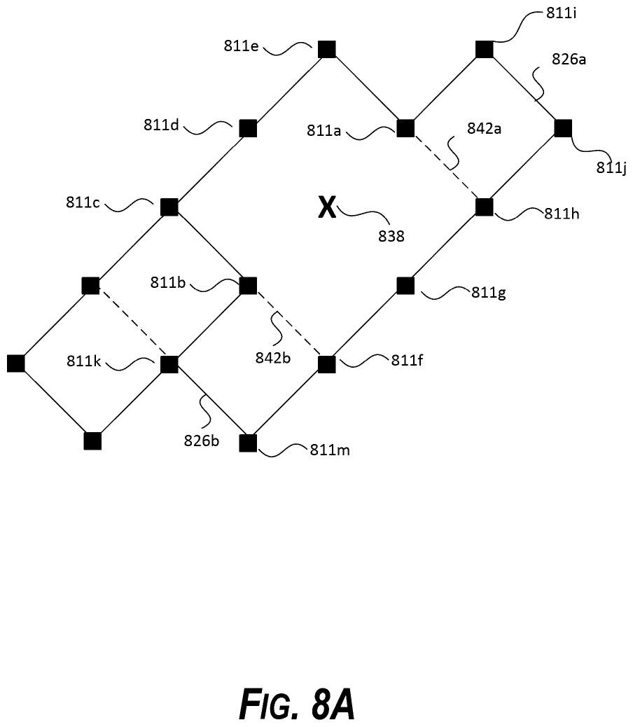

FIG. 7A depicts a schematic diagram of an example quantum computing system comprising a dropout coupler in a third location within a hexagonal grid of qubit structures according to example implementations of some aspects of the present disclosure. A dropout coupler 720 and a first omitted coupler 742a can each be associated with a first local detection region 726a of a quantum error correction code, on opposite edges (i.e., non-adjacent edges; edges that do not share a qubit 111, etc.) of the first local detection region 726a. The dropout coupler 720 and a second omitted coupler 742b can each be associated with a second local detection region 726b of the quantum error correction code, on opposite edges (i.e., non-adjacent edges; edges that do not share a qubit 111, etc.) of the second local detection region 726b.

FIG. 7B depicts a schematic diagram of a plurality of example gauge operators and stabilizers for performing quantum error correction in an example quantum computing system comprising a dropout coupler in a third location within a hexagonal grid of qubit structures according to example implementations of some aspects of the present disclosure.

A quantum error correction operation can include measuring, at a mid-cycle state 108 of a quantum error correction code (e.g., surface code, subsystem code, etc.), a first weight-2 mid-cycle gauge operator 740a associated with a first and second qubit 111 of the first local detection region 726a and a second weight-2 mid-cycle gauge operator 740b associated with a third and fourth qubit 111 of the first local detection region 726a. The quantum error correction operation can further include measuring, at a mid-cycle state 108 of a quantum error correction code (e.g., surface code, subsystem code, etc.), a third weight-2 mid-cycle gauge operator 740c associated with a first and second qubit 111 of the second local detection region 726b and a fourth weight-2 mid-cycle gauge operator 740d associated with a third and fourth qubit 111 of the second local detection region 726b. The quantum error correction operation can further include measuring, at a mid-cycle state 108 of a quantum error correction code (e.g., surface code, subsystem code, etc.), a first weight-four gauge operator 728a associated with a third local detection region 726c. The quantum error correction operation can further include measuring, at a mid-cycle state 108 of a quantum error correction code (e.g., surface code, subsystem code, etc.), a second weight-four gauge operator 728b associated with a third local detection region 726d.

FIG. 7C depicts a schematic diagram of an example method for combining gauge operators to generate a stabilizer for an example quantum computing system comprising a dropout coupler in a third location within a hexagonal grid of qubit structures according to example implementations of some aspects of the present disclosure. A quantum error correction operation can include, for example, combining a third weight-2 gauge operator 740c, fourth weight-2 gauge operator 740d, and first weight-4 gauge cycle operator 728a to generate a first weight-8 stabilizer 750a associated with eight qubits 111 of the second and third local detection regions 726b, 726c.

FIG. 7D depicts a schematic diagram of an example method for combining gauge operators to generate a stabilizer for an example quantum computing system comprising a dropout coupler in a third location within a hexagonal grid of qubit structures according to example implementations of some aspects of the present disclosure. A quantum error correction operation can include, for example, combining a first weight-2 gauge operator 740a, second weight-2 gauge operator 740b, and second weight-4 gauge operator 728b to generate a second weight-8 stabilizer 750b associated with eight qubits 111 of the first and fourth local detection regions 726a, 726d.

Although FIGS. 7A-7D depict a hexagonal grid having dropout and omitted couplers 720, 742 on opposite sides of a local detection region 726, it will be appreciated that this scenario can be topologically equivalent to a square grid having two dropout couplers 720 on opposite sides of a local detection region 726, and that operations depicted with respect to hexagonal grids in FIGS. 7A-7D can be similarly applied to square grids or other grid topologies.

In some instances, a quantum error correction code implemented according to aspects of FIGS. 7B-7D can have an X-distance and a Z-distance that are each reduced by one compared to a corresponding quantum error correction code without a dropout coupler 720, which can be a smaller reduction in distance than some alternative implementations.

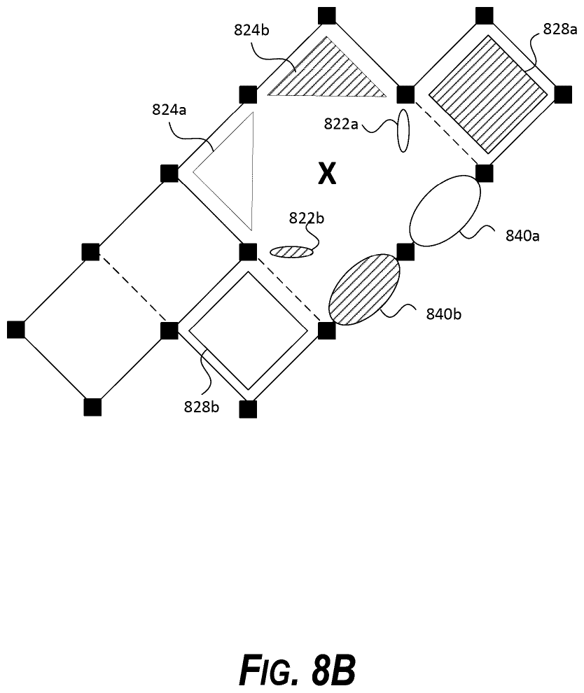

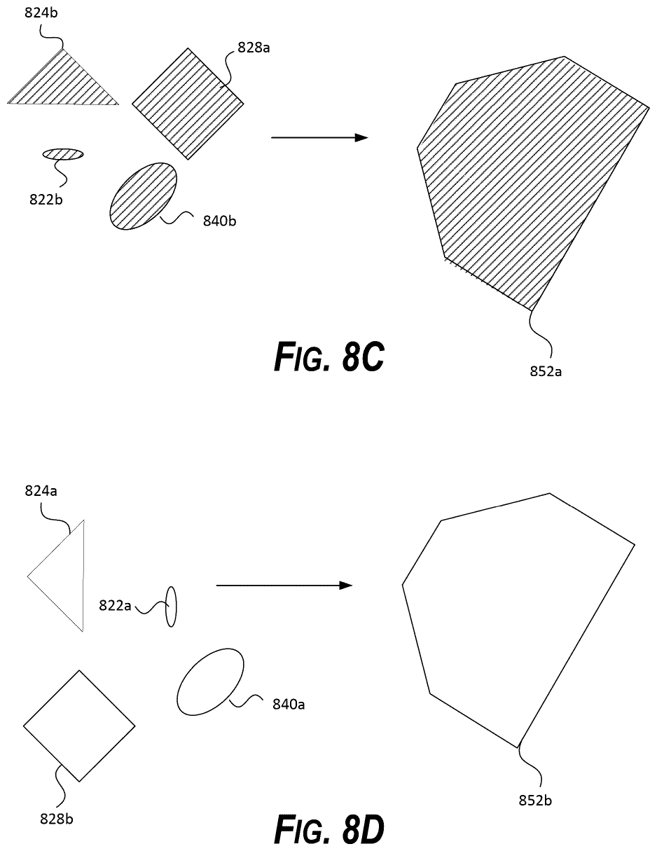

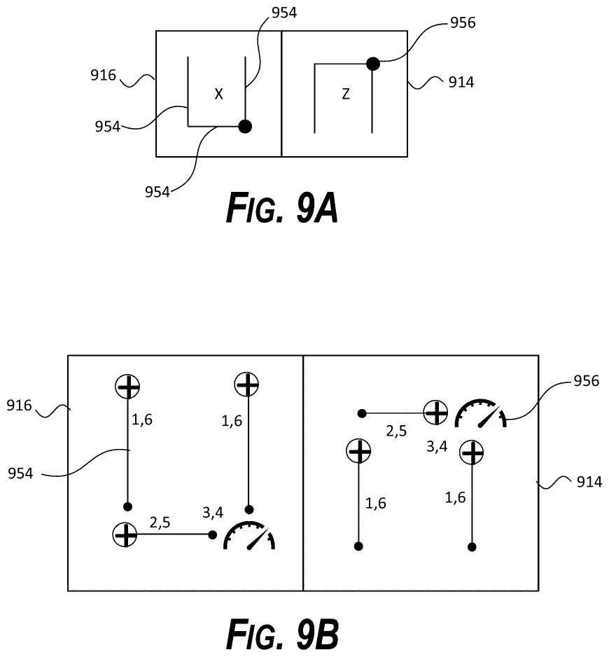

FIG. 8A depicts a schematic diagram of an example quantum computing system comprising a dropout qubit structure in a hexagonal grid of qubit structures according to example implementations of some aspects of the present disclosure. A dropout qubit 838 can be adjacent to a first qubit 811a that is adjacent to a first omitted coupler 842a. The dropout qubit 838 can be adjacent to a second qubit 811b that is adjacent to a second omitted coupler 842b.

FIG. 8B depicts a schematic diagram of a plurality of example gauge operators and stabilizers for performing quantum error correction in an example quantum computing system comprising a dropout qubit structure in a hexagonal grid of qubit structures according to example implementations of some aspects of the present disclosure. A quantum error correction operation can include measuring, at a mid-cycle state 108 of a quantum error correction code (e.g., surface code, subsystem code, etc.), a first weight-1 gauge operator 822a associated with the first qubit 811a. The quantum error correction operation can further include measuring, at a mid-cycle state 108 of a quantum error correction code (e.g., surface code, subsystem code, etc.), a second weight-1 gauge operator 822b associated with the second qubit 811b. The quantum error correction operation can further include measuring, at a mid-cycle state 108 of a quantum error correction code (e.g., surface code, subsystem code, etc.), a first weight-2 gauge operator 840a associated with qubits 811g, 811h of FIG. 8A. The quantum error correction operation can further include measuring, at a mid-cycle state 108 of a quantum error correction code (e.g., surface code, subsystem code, etc.), a second weight-2 gauge operator 840b associated with qubits 811f, 811g of FIG. 8A. The quantum error correction operation can further include measuring, at a mid-cycle state 108 of a quantum error correction code (e.g., surface code, subsystem code, etc.), a first three-qubit gauge operator 824a associated with qubits 811b, 811c, 811d of FIG. 8A. The quantum error correction operation can further include measuring, at a mid-cycle state 108 of a quantum error correction code (e.g., surface code, subsystem code, etc.), second three-qubit gauge operator 824b associated with qubits 811a, 811d, 811e of FIG. 8A. The quantum error correction operation can further include measuring, at a mid-cycle state 108 of a quantum error correction code (e.g., surface code, subsystem code, etc.), a first weight-four gauge operator 828a associated with a first local detection region 826a. The quantum error correction operation can further include measuring, at a mid-cycle state 108 of a quantum error correction code (e.g., surface code, subsystem code, etc.), a second weight-four gauge operator 828b associated with a second local detection region 826b.

FIG. 8C depicts a schematic diagram of an example method for combining gauge operators to generate a stabilizer for an example quantum computing system comprising a dropout qubit structure in a hexagonal grid of qubit structures according to example implementations of some aspects of the present disclosure. A quantum error correction operation can include, for example, combining a second weight-1 gauge operator 822b, second weight-3 gauge operator 824b, second weight-2 gauge operator 840b, and first weight-four gauge operator 828a to generate a first weight-8 stabilizer 852a associated with qubits 811b, 811d, 811e, 811f, 811g, 811h, 811i, 811j of FIG. 8A.

FIG. 8D depicts a schematic diagram of an example method for combining gauge operators to generate a stabilizer for an example quantum computing system comprising a dropout qubit structure in a hexagonal grid of qubit structures according to example implementations of some aspects of the present disclosure. A quantum error correction operation can include, for example, combining a first weight-1 gauge operator 822a, first weight-3 gauge operator 824a, first weight-2 gauge operator 840a, and second weight-four gauge operator 828b to generate a second weight-8 stabilizer 852b associated with qubits 811a, 811c, 811d, 811f, 811g, 811h, 811k, 811m of FIG. 8A.

In some instances, a quantum error correction code implemented according to aspects of FIGS. 8B-8D can have a distance that is only one less in each of two bases (e.g., X basis, Z basis, etc.) compared to a corresponding quantum error correction code without a dropout qubit 838, which can be a smaller reduction in distance than some alternative implementations.

FIG. 9A depicts a schematic diagram of a first example notation for describing an example method for determining one or more stabilizers according to example implementations of some aspects of the present disclosure. In some instances, a weight-4 stabilizer can be measured by performing one or more quantum gating operations (e.g., two-qubit CNOT gating operations, etc.) to generate a state of a first qubit 956 of a four-qubit local detection region 914, 916 that is dependent on a state of each of a second, third, and fourth qubit of the four-qubit local detection region 914, 916; and then measuring a quantum state of the first qubit 956. In the first example notation of FIG. 9A, each gating operation 954 can be depicted as an interior line segment in the diagram, and the first qubit 956 of each four-qubit local detection region 914, 916 can be depicted as a dot indicating which of four qubits is to be measured.

A local detection region 914 can include, for example, a region comprising a plurality of qubits associated with a Z stabilizer 114 (e.g., mid-cycle stabilizer 114b, etc.) to be measured in a Z basis. A local detection region 916 can include, for example, a region comprising a plurality of qubits associated with an X stabilizer 116 (e.g., mid-cycle stabilizer 116b, etc.) to be measured in an X basis.

FIG. 9B depicts a schematic diagram of a second example notation for describing the example method of FIG. 9A. In some instances, a weight-4 stabilizer can be measured by performing one or more quantum gating operations (e.g., two-qubit CNOT gating operations, etc.) to generate a state of a first qubit 956 of a four-qubit local detection region 914, 916 that is dependent on a state of each of a second, third, and fourth qubit of the four-qubit local detection region 914, 916; and then measuring a quantum state of the first qubit 956. In the second example notation of FIG. 9B, each gating operation 954 can be depicted in quantum circuit diagram notation, and a first qubit 956 to be measured can be indicated by a measurement icon.

FIG. 9C depicts a schematic diagram of a third example notation for describing a first portion of the example method of FIG. 9A. In some instances, a weight-4 stabilizer in an X basis can be measured by performing one or more quantum gating operations (e.g., two-qubit CNOT gating operations, etc.) to generate a state of a first qubit 956 of a four-qubit local detection region 916 that is dependent on a state of each of a second, third, and fourth qubit of the four-qubit local detection region 916; and then measuring a quantum state of the first qubit 956. For example, in some instances, a method for measuring a weight-4 stabilizer in an X basis can include a contraction phase comprising a plurality of quantum gating operations (e.g., CNOT operations); a measurement operation measuring the first qubit 946 in an X basis; a reset operation; and an expansion operation comprising a plurality of quantum gating operations (e.g., CNOT operations, etc.). The example notation on the right side of FIG. 9C can include standard quantum circuit diagram notation, and the example notation on the left side of FIG. 9C can be a simplified notation for representing the same circuit depicted on the right side of FIG. 9C.

FIG. 9D depicts a schematic diagram of a third example notation for describing a second portion of the example method of FIG. 9A. In some instances, a weight-4 stabilizer in a Z basis can be measured by performing one or more quantum gating operations (e.g., two-qubit CNOT gating operations, etc.) to generate a state of a first qubit 956 of a four-qubit local detection region 914 that is dependent on a state of each of a second, third, and fourth qubit of the four-qubit local detection region 914; and then measuring a quantum state of the first qubit 956. For example, in some instances, a method for measuring a weight-4 stabilizer in a Z basis can include a contraction phase comprising a plurality of quantum gating operations (e.g., CNOT operations); a measurement operation measuring the first qubit 946 in a Z basis; a reset operation; and an expansion operation comprising a plurality of quantum gating operations (e.g., CNOT operations, etc.). The example notation on the right side of FIG. 9D can include standard quantum circuit diagram notation, and the example notation on the left side of FIG. 9D can be a simplified notation for representing the same circuit depicted on the right side of FIG. 9D.

FIG. 10 depicts a schematic diagram of an example quantum error correction code for a hexagonal topological grid of qubits in the absence of dropout devices according to example implementations of some aspects of the present disclosure. A quantum computing system can include a hexagonal grid (e.g., hexagonal grid as depicted with respect to 5B, etc.) comprising a plurality of hexagonal regions. In some instances, each hexagonal region can include a Z detection region 914 and an X detection region 916. In some instances, a plurality of contraction operations (e.g., contraction operations described above with respect to FIG. 9D, etc.) can shrink one or more half-cycle states such that only couplers 118 on the hexagonal grid are required to measure one or more half-cycle stabilizers 114b, 116b. In this manner, for instance, a quantum error correction code (e.g., stabilizer code, etc.) can be implemented using a hexagonal grid.

In some instances, using a pair of CNOT gates, a weight-4 bulk mid-cycle stabilizer can be “folded” into a pair of qubits along one edge of the square. This weight-2 operator can then be folded again using a single CNOT gate, after which it can be measured and reset, and then unfolded back into the original weight-4 footprint. Adjacent midcycle stabilizers can be measured simultaneously using a “snake” configuration where the gates are positioned such that the CNOT gates for the initial circuit layer fold both stabilizers simultaneously.

To do this, one can start by finding a set of mid-cycle stabilizer generators which are compatible with the dropout grid in question. Some of these stabilizers may be composed of multiple midcycle gauge operators multiplied together (e.g., according to a subsystem code dropout construction, etc.). One can then measure these mid-cycle gauges and stabilizers over multiple rounds. A quantum error correction circuit can cycle through these rounds sequentially, with the mid-cycle state acting as a “home base” that can be used to hand off between different rounds. In some instances, detector cross-sections at the measurement round, which are normally what are referred to as the stabilizers of the code, may not be constant over time, while the mid-cycle stabilizers of some example circuits disclosed herein can remain fixed. In some instances, a process for finding logical operators can include finding an error string in the mid-cycle state from one corner to another, and then propagating it through the circuit.

In some instances, a first plurality of stabilizers 914, 916 and a second plurality of stabilizers 914, 916 can be measured in alternating rounds. In some instances, each round can measure some subset of the mid-cycle stabilizers of the code in place. As a non-limiting illustrative example, in some instances, alternating rows of detection regions can be measured in successive rounds. For example, a first row spanning from first stabilizer 1060a to second stabilizer 1060b can be measured in a first round; second and third rows adjacent to the first row (e.g., second row comprising stabilizers 1060c, 1060d; third row comprising stabilizers 1060e, 1060f; etc.) can be measured in the second round; stabilizers adjacent to the second and third rows can be measured in the first round at the same time as the first row; and so on. FIGS. 9C-9D above show how the shapes depicted in FIG. 10 can be compiled into quantum circuits. In the contracting stage of the round, CNOT gates can propagate the information to a single qubit and measure it. Then, in the expanding stage of the round, the same qubit can be reset, and then the CNOT gates can be repeated in reversed order to spread the information back to the original footprint. In some instances in which each mid-cycle stabilizer is measured in one of the rounds, the full distance of the code can be achieved.

In some instances, interior lines of FIG. 10 depicting gating operations 954 can describe how the mid-cycle stabilizer will be measured, with the lines indicating which entangling operations are used and the dot indicating which qubit is measured, as shown in FIGS. 9B-9D. As a result, compatibility rules can be used for adjacent shapes to ensure that the resulting circuits never have a gate collision, where two distinct gates use a shared qubit in the same round. For example, in some instances, a compatibility rule can include a rule that a layer-1 CNOT gate between the shared qubits must be identical, or a rule that the layer-2 CNOT gates on the shared qubits must not overlap. In some instances (e.g., in local quantum computing system regions where no dropout devices are present, etc.), such compatibility rules can lead to alternating-row measurement operations, where a full row of mid-cycle stabilizers can be measured simultaneously using shared layer-1 CNOTs and alternating layer-2 CNOTs.

In some instances, the notation depicted in FIG. 10 can make it easy to switch the qubits that are measured without impacting compatibility in most cases. As a result, it can be straightforward to build circuits in the notation of FIG. 10 (sometimes referred to as “LUCI” or “LUCi” notation due to the L, U, C, and I shapes of aspects of the notation; diagrams in LUCI notation can be referred to as “LUCI diagrams”) that switch data qubit and measure qubit roles, which can be impactful for leakage errors. One could do this within a usual four-round cycle, or double the cycle to eight rounds and switch qubit roles for the second half of the set of eight. This sort of flexibility is one technical effect and benefit of some aspects of the present disclosure, as systems and methods described herein can enable easy modification of a quantum computing circuit (e.g., quantum error correction circuit, etc.) to measure particularly leaky qubits more often than others without much difficulty (e.g., by designing a circuit using LUCI diagrams and/or compatibility rules and then compiling the diagram to a circuit, etc.).

In some instances, a LUCI diagram can correspond to a circuit according to one or more relationships described in this paragraph and the following paragraph. For example, a LUCI diagram can correspond to a quantum circuit built in the following manner: To start, one can use a “half round”, where one takes the first round and only uses the circuit from the resets onwards, while also initializing the remaining qubits in the desired initial logical basis. The two subsequent CNOT layers can serve to get one into the midcycle state from this point. One can then cycle between the different rounds in order, appending one less round than a desired number of total rounds to account for the half rounds. To measure, one can do another half round, this time using just the first two CNOT layers and the measurement layer for the last round, and then also measure all the other qubits in the desired measurement basis. This can give the operations for a full memory experiment.

For the detectors, one may have to be more careful than in the standard surface code case. Unlike the standard case, boards avoiding certain dropouts may pull detecting regions outwards before returning them into their usual position, leading to detectors that consist of a number of different measurements on different qubits. A detecting region according to some aspects of the present disclosure can start at a reset, after which it can take two CNOT layers to expand into a mid-cycle stabilizer. The next round may not measure this same mid-cycle stabilizer, but the detecting region can be manipulated by the measurement of nearby mid-cycle stabilizers of the same type, before being returned to its original position, possibly having passed through a measurement on the way. It then can be folded and measured fully, completing the region. As such, each detector in the bulk can consist of a terminal measurement, along with other measurements and resets that the detecting region passed through along the way.

In some instances, quantum error correction circuits described herein (e.g., with respect to FIGS. 2A-10, etc.) can be constructed from a small set of different rounds, each starting and ending in a modified mid-cycle state of the surface code. In some instances, quantum error correction circuits described herein can include error correction circuits where the standard stabilizers of the quantum error correcting code are propagated through the circuit to form so-called “detecting regions.”

In some instances, gauge operators can be measured a plurality of times in a first basis (e.g., X basis, Z basis, etc.) before switching to a second basis (e.g., X basis, Z basis, etc.) that is different from the first basis. In this manner, for instance, one can treat gauge operators like stabilizers in the successive repetitions. In some instances, a superstabilizer can be used only in a first round of a given basis, as individual gauges may in some instances be scrambled by the measurements of the opposite basis. In some instances, a gauge measurement can be repeated around a dropout device a number of times that is proportional to a size (e.g., patch diameter, etc.) of the dropout region. In some instances, global X and Z layers can be used to study different ways to weight the patch diameters in the circuit. In some instances, applying such operations to quantum error correction circuits described herein can include simply repeating the first two rounds of a diagrammed circuit (e.g., circuit described herein with respect to FIGS. 2A-10, etc.), then repeating a second pair of rounds of the diagrammed circuit, using any appropriate weighting. In some instances, mixed-basis rounds can be used to repeat larger dropout regions more than smaller ones. However, in some instances, such repetition can be avoided (e.g., to reduce an amount of time required per error correction cycle, etc.), and good quantum error correction results can be achieved without such repetition (e.g., due to a small size of dropout regions and small size of super-stabilizers generated from a plurality of gauge operators in some example circuits, etc.).

In some instances, quantum error correction circuits according to aspects of the present disclosure can be used to perform one or more logical gating operations (e.g., any logical gate operation that can be performed by a standard surface code in the absence of dropout qubits, etc.). For example, the boundaries of some quantum error correction circuits according to aspects of the present disclosure can be the same as boundaries of some standard surface codes, so lattice surgery can be a viable option for logical Bell measurements and CNOT operations in some instances.

In some instances, some error correction circuits according to some aspects of the present disclosure can include circuits that may be anisotropic; aperiodic; or both. In some instances, some error correction circuits according to some aspects of the present disclosure can even include circuits with one or more randomly generated components. In some instances, some error correction circuits according to some aspects of the present disclosure can even include circuits that do not measure a consistent end-cycle error correcting code. In some instances, error correction circuits according to some aspects of the present disclosure (e.g., anisotropic, aperiodic, or randomly generated circuits; circuits that do not measure a consistent end-cycle error correcting code) may be a possible step toward code-free fault-tolerant processes.

It should be noted that embodiments may in some instances be generalized to other types of stabilizer measurements, such as flags. The embodiments may be generalized to circumstances where stabilizers can be reconstructed from gauge operators and other stabilizers, resets, or measurements, such as in surface-code movement or lattice surgery. Local detection regions (and thus stabilizers and gauge operators) are not restricted to “X-type” and “Z-type”. They can be generalized to anything locally equivalent to X-type and Z-type. Local equivalence can mean applying a transformation that is a single-qubit Clifford gate at each data qubit. It can be shown that this preserves pairwise commutation among stabilizers, pairwise commutation between any stabilizer and gauge operator, and commutation-or-not among pairs of gauge operators, e.g., X/Y surface codes and/or XZZX surface codes. Systems and methods described herein can in some instances generalize to other circuit decompositions that use a two-qubit entangling operation, such as the controlled-Z gate or two-qubit parity measurement.

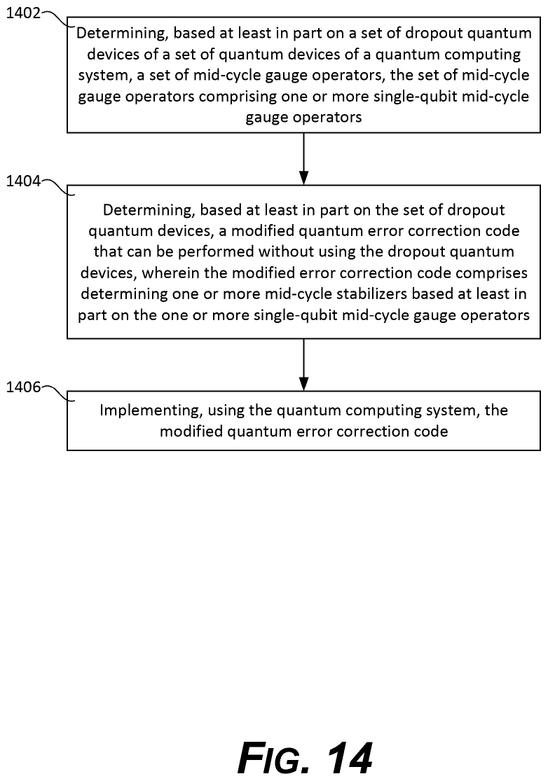

Further details of an example method for building (e.g., designing, compiling, etc.) error correction circuits according to some aspects of the present disclosure are provided below with respect to FIG. 12.

FIG. 11 depicts a schematic diagram of an example method for combining gauge operators to generate a stabilizer for an example quantum computing system a square grid of qubits comprising one dropout qubit 1138 according to example implementations of some aspects of the present disclosure. A plurality of three-qubit gauge operators 1124a, 1124b, 1124c, and 1124d can be measured. The first and second three-qubit gauge operators 1124a, 1124b can be combined to generate a corresponding weight-6 stabilizer in an X basis. The third and fourth three-qubit gauge operators 1124c, 1124d can be combined to generate a corresponding weight-6 stabilizer in a Z basis. In some instances, a quantum error correction code implemented according to aspects of FIG. 11 can have a distance that is only one less in each of two bases (e.g., X basis and Z basis, etc.) compared to a corresponding quantum error correction code without a dropout qubit 1138, which can be a smaller reduction in distance than some alternative implementations.

FIG. 12 depicts a flowchart diagram of an example method for designing a quantum error correction circuit according to example embodiments of the present disclosure. Although FIG. 12 depicts steps performed in a particular order for purposes of illustration and discussion, the methods of the present disclosure are not limited to the particularly illustrated order or arrangement. The various steps of example method 1200 can be omitted, rearranged, combined, and/or adapted in various ways without deviating from the scope of the present disclosure.

At 1202, example method 1200 can include determining, based at least in part on a set of dropout devices of a quantum computing system, a plurality of mid-cycle gauge operators associated with a mid-cycle state of a quantum error correction code. In some instances, example method 1200 at 1202 can include using one or more systems or performing one or more activities described with respect to FIG. 2A-11. For example, in some instances, example method 1200 at 1202 can include mapping a dropout configuration of a local region of a quantum computing system to a corresponding set of gauge operators depicted in one or more of FIGS. 2A-11. In some instances, example method 1200 at 1202 can include treating each coupler adjacent to a dropout qubit as a dropout coupler. In some instances, example method 1200 at 1202 can include identifying one or more connected subsets (e.g., connected graphs of a graph wherein each qubit is treated as a node and each coupler is treated as an edge, etc.) of one or more mid-cycle local detection regions 114b, 116b of a mid-cycle state of a quantum error correction code (e.g., surface code, etc.); and mapping each connected subset to a corresponding mid-cycle gauge operator. In some instances, like in a subsystem code, such gauge operators can commute with all stabilizers of the quantum error correction code, but may anticommute with other gauge operators (e.g., mid-cycle gauge operators, etc.).

At 1204, example method 1200 can include determining, based at least in part on the plurality of mid-cycle gauge operators, a plurality of stabilizers, each stabilizer comprising a product of two or more mid-cycle gauge operators of the plurality of mid-cycle gauge operators. In some instances, example method 1200 at 1204 can include using one or more systems or performing one or more activities described with respect to FIGS. 2A-11.

In some instances, since extending stabilizers into detecting regions can keep commutation relations, example method 1200 at 1204 can include performing this grouping in the mid-cycle, in some instances getting the same results as grouping in the end-cycle state. In some instances, this grouping problem can admit multiple solutions. In some instances, example method 1200 at 1204 can include choosing groupings that reduce (e.g., minimize or nearly minimize, etc.) super-stabilizer size compared to some alternative groupings. In some instances, such a process can be thought of as multiplying stabilizer generators of the same type that touch a given broken qubit, forming new stabilizers which are not supported on the qubit in question. In some instances, the only differences between the midcycle and full-cycle versions of this protocol can be differences that come up when multiple components are broken near each other, where the mid-cycle case occasionally may have to measure a shape using two gauges since the measurements may be made in place as opposed to using a measurement qubit. This occasionally may cause gauges that usually commute to split into two gauges, which may no longer commute with a given super-stabilizer. In this case, it may be necessary to merge two super-stabilizers together (e.g., as depicted with respect to FIGS. 6C-6D, etc.). Additionally, broken qubits near some boundaries (e.g., boundaries of a quantum computing system, boundaries of a topological grid of qubits, boundaries of a logical qubit, etc.) may lead to gauges which cannot be paired, and must be removed.

At 1206, example method 1200 can include determining, based at least in part on the plurality of stabilizers, a plurality of mid-cycle logical operators. In some instances, example method 1200 at 1206 can include starting by identifying the corners of the code, qubits which are in a single stabilizer of each type. In some instances, logical X(Z) operators, can be found by connecting two corners on opposite X(Z) boundaries of the mid-cycle state with operators that touch each stabilizer or gauge of the opposite type an even number of times. In some instances, the logical operator must commute with each gauge, not just each mid-cycle super-stabilizer, to avoid being scrambled by measurements. Otherwise measuring gauge operators may interfere with the logical operator. In the detecting region picture, these logical operators can be sheets in the 2+1-dimensional view of the circuit, so identifying the logical operator at the mid-cycle can fully define the operator at all other time slices. Over the course of the circuit the logical operator can move due to CNOT gates, but return to the same support for each mid-cycle state.

At 1208, example method 1200 can include obtaining data indicative of a dropout-free quantum error correction code (e.g., four-coupler surface code, three-coupler surface code for hexagonal grid, etc.). In some instances, such data can include a base diagram for a 4-coupler surface code. This circuit can be nearly identical to the usual surface code, except that the CNOT order for the stabilizer measurements can be reversed every other round. An interesting aside is that the resulting detecting regions can be modified, such that they can be thought of as trapezoids instead of parallelograms. This can have an impact on performance depending on the error model. The other difference between the usual circuit and an example 4-coupler circuit code is at the boundaries, where the example 4-coupler circuit may not have the usual alternating stabilizer configuration at the boundary. This does not appreciably change performance, and these additional qubits can be removed in a final clean-up step if beneficial under the relevant error model.

At 1210, example method 1200 can include adding, to the data indicative of the dropout-free quantum error correction code, data indicative of mid-cycle measurement circuitry for measuring the plurality of mid-cycle gauge operators to generate data indicative of a resulting error correction circuit. In some instances, example method 1200 at 1210 can include using one or more systems or performing one or more activities described with respect to FIGS. 2A-11.

In some instances, example method 1200 at 1210 can optionally include applying a four-coloring to the mid-cycle state, such that every shape is colored in only one round and there are no overlapping qubits. One can add in shapes to measure the empty mid-cycle gauges and stabilizers, but only in the rounds where they are colored. This constraint can in some instances ensure that every shape is measured over the four rounds. In some instances, one can select a four-coloring such that the stabilizers and gauges highlighted in the first two rounds are Z-type and the second two are X-type. This can enable combining gauges into super-stabilizers before their eigenvalues are scrambled by the anti-commuting gauges of the other basis.

At 1212, example method 1200 can include modifying the data indicative of the resulting error correction circuit to remove conflicts between neighboring circuitry. In some instances, example method 1200 at 1212 can optionally further include additional post-processing and optimization. As an example, more measurements can be added by flipping rows to avoid incompatibility issues, but having rows in a given round that face each other leads to detecting regions of varying sizes, as one basis will get stretched far more than the other. This leads to worsened performance when decoding and logical error rate biases. Additional optimizations include removing boundary qubits which are only ever used by single-qubit mid-cycle stabilizers and as the far end qubit of weight-4 stabilizers, as the weight-4 stabilizer could be converted into an L-shape without damaging the code. This would reduce the footprint of the code, reducing calibration overhead. In addition, LUCI circuits can be generated by randomly sampling arbitrary applicable shapes in the subgrids of method 1200 at 1210. The framework of LUCI can in some instances ensure that the detecting regions only span 4 rounds, so this could be used to create aperiodic and anisotropic error correcting circuits which still maintain spacelike distance and perform reasonably close to the usual surface code. Such circuits may not be relevant for most platforms, but are interesting in terms of vastly expanding the space of circuits usable for error correction, and could be useful for random compiling.

In some instances, example method 1200 can further include (e.g., at 1212, etc.) implementing (e.g., compiling, executing on a quantum computing system, etc.) one or more quantum computing operations determined according to example method 1200.

FIG. 13 depicts a flowchart diagram of an example method for quantum error correction according to example embodiments of the present disclosure. Although FIG. 13 depicts steps performed in a particular order for purposes of illustration and discussion, the methods of the present disclosure are not limited to the particularly illustrated order or arrangement. The various steps of example method 1300 can be omitted, rearranged, combined, and/or adapted in various ways without deviating from the scope of the present disclosure.

At 1302, example method 1300 can include measuring, at one or more mid-cycle states of a quantum error correction code executing on a quantum computing system, one or more mid-cycle gauge operators and one or more mid-cycle stabilizers, wherein the one or more mid-cycle gauge operators comprise one or more single-qubit mid-cycle gauge operators. In some instances, example method 1300 at 1302 can include using one or more systems or performing one or more activities described with respect to FIGS. 2A-11.

At 1304, example method 1300 can include performing, based at least in part on a result of the measuring, a quantum error correction operation. In some instances, example method 1300 at 1304 can include using one or more systems or performing one or more activities described with respect to FIGS. 2A-11. Performing a quantum error correction operation can include, for example, detecting one or more error states of one or more qubits (e.g., physical qubit devices, logical qubits encoded in a plurality of physical qubit devices, etc.); determining a corrected quantum state of one or more qubits; performing one or more quantum gating actions to correct a detected error; or other quantum error correction operation.

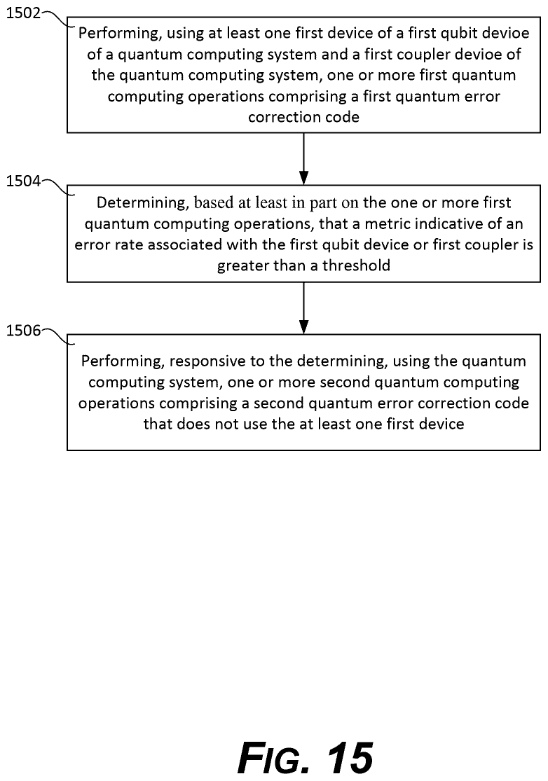

FIG. 14 depicts a flowchart diagram of an example method for quantum error correction according to example embodiments of the present disclosure. Although FIG. 14 depicts steps performed in a particular order for purposes of illustration and discussion, the methods of the present disclosure are not limited to the particularly illustrated order or arrangement. The various steps of example method 1400 can be omitted, rearranged, combined, and/or adapted in various ways without deviating from the scope of the present disclosure.

At 1402, example method 1400 can include determining, based at least in part on a set of dropout quantum devices of a set of quantum devices of a quantum computing system, a set of mid-cycle gauge operators, the set of mid-cycle gauge operators comprising one or more single-qubit mid-cycle gauge operators. In some instances, example method 1400 at 1402 can include using one or more systems or performing one or more activities described with respect to FIGS. 2A-11.

At 1404, example method 1400 can include determining, based at least in part on the set of dropout quantum devices, a modified quantum error correction code that can be performed without using the dropout quantum devices, wherein the modified error correction code comprises determining one or more mid-cycle stabilizers based at least in part on the one or more single-qubit mid-cycle gauge operators. In some instances, example method 1400 at 1404 can include using one or more systems or performing one or more activities described with respect to FIGS. 2A-11.

At 1406, example method 1400 can include implementing, using the quantum computing system, the modified quantum error correction code. In some instances, example method 1400 at 1406 can include using one or more systems or performing one or more activities described with respect to FIG. 10.

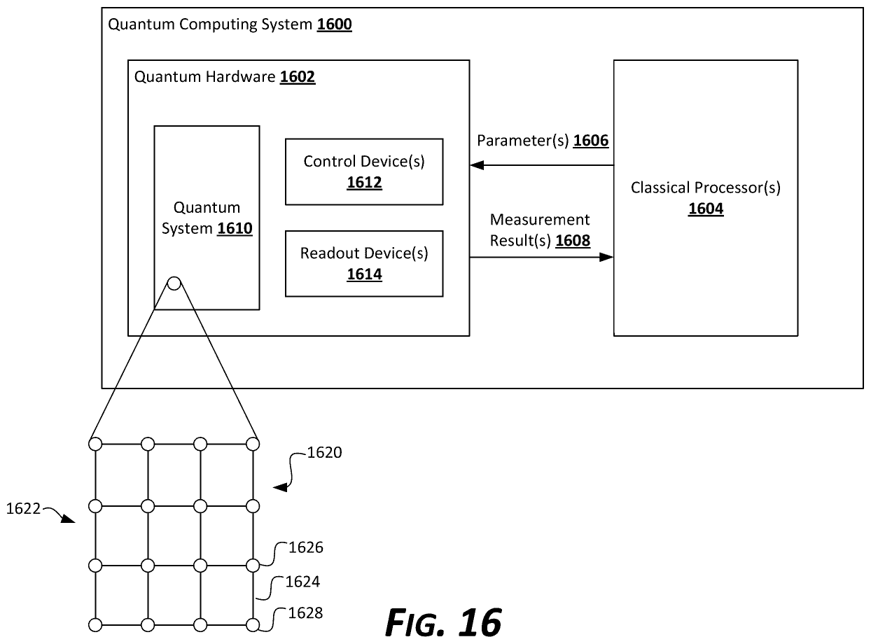

FIG. 15 depicts a flowchart diagram of an example method for quantum computation according to example embodiments of the present disclosure. Although FIG. 15 depicts steps performed in a particular order for purposes of illustration and discussion, the methods of the present disclosure are not limited to the particularly illustrated order or arrangement. The various steps of example method 1500 can be omitted, rearranged, combined, and/or adapted in various ways without deviating from the scope of the present disclosure.

At 1502, example method 1500 can include performing, using at least one first device of a first qubit device of a quantum computing system and a first coupler device of the quantum computing system, one or more first quantum computing operations comprising a first quantum error correction code. In some instances, example method 1500 at 1502 can include using one or more systems or performing one or more activities described with respect to FIGS. 2A-11.

At 1504, example method 1500 can include determining, based at least in part on the one or more first quantum computing operations, that a metric indicative of an error rate associated with the first qubit device or first coupler is greater than a threshold. In some instances, example method 1500 at 1504 can include using one or more systems or performing one or more activities described with respect to FIGS. 2A-11. Example metrics indicative of an error rate can include, for example, a detection event fraction of a quantum error correction code; a decoherence rate metric associated with a qubit structure (e.g., T1 relaxation time, T2 dephasing time, etc.); data indicative of one or more frequency ranges associated with one or more two-level system defects (e.g., data indicative of a plurality of decoherence time metrics of a qubit structure at a plurality of qubit frequencies, etc.); or other data indicative of an error rate. In some instances, data indicative of an error rate can include measured data (e.g., measurements of past error rate data of the quantum computing system), predicted data (e.g., predictions of future error rate data, such as predictions of TLS defect frequency based on past time-dependent TLS defect behavior, etc.), or some combination thereof.

At 1506, example method 1500 can include performing, responsive to the determining, using the quantum computing system, one or more second quantum computing operations comprising a second quantum error correction code that does not use the at least one first device. In some instances, example method 1500 at 1506 can include using one or more systems or performing one or more activities described with respect to FIGS. 2A-11.

FIG. 16 depicts an example quantum computing system 1600. The example system 1600 is an example of a system on one or more classical computers or quantum computing devices in one or more locations, in which the systems, components, and techniques described below can be implemented. Those of ordinary skill in the art, using the disclosures provided herein, will understand that other quantum computing structures or systems can be used without deviating from the scope of the present disclosure.

The system 1600 includes quantum hardware 1602 in data communication with one or more classical processors 1604. The quantum hardware 1602 includes components for performing quantum computation. For example, the quantum hardware 1602 includes a quantum system 1610, control device(s) 1612, and readout device(s) 1614 (e.g., readout resonator(s)). The quantum system 1610 can include one or more multi-level quantum subsystems, such as a register of qubits. In some implementations, the multi-level quantum subsystems can include superconducting qubits, such as flux qubits, charge qubits, transmon qubits, gmon qubits, etc. In some instances, the superconducting qubits may be located in a cryostat to cool the qubits to superconducting temperatures (e.g., less than about 3 Kelvin). However, aspects of the present disclosure are not limited to superconducting qubits. In some examples, any suitable qubit structure may be used without deviating from the scope of the present disclosure, such as photonic qubits, trapped ion qubits, spin qubits, neutral atom qubits, quantum dot qubits, molecular qubits, or other qubits.

The type of multi-level quantum subsystems that the system 1600 utilizes may vary. For example, in some cases it may be convenient to include one or more readout device(s) 1614 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 1610 via multiple control lines that are coupled to one or more control devices 1612. Example control devices 1612 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 1612 may be configured to operate on the quantum system 1610 through one or more respective control parameters (e.g., one or more physical control parameters). For example, in some implementations, the multi-level quantum subsystems may be superconducting qubits and the control devices 1612 may be configured to provide control pulses to control lines to generate magnetic fields to adjust the frequency of the qubits. As another example, in some implementations the multi-level quantum subsystems may be neutral atom qubits and the control devices 1612 may be configured to provide control pulses to control lines to generate magnetic, optical, or acoustic control outputs (e.g., laser pulses, optical tweezers, acousto-optic deflectors, magneto-optical traps, etc.) to control the qubits.

The quantum hardware 1602 may further include readout devices 1614 (e.g., readout resonators). Measurement results 1608 obtained via measurement devices may be provided to the classical processors 1604 for processing and analyzing. In some implementations, the quantum hardware 1602 may include a quantum circuit and the control device(s) 1612 and readout devices(s) 1614 may implement one or more quantum logic gates that operate on the quantum system 1602 through physical control parameters (e.g., microwave pulses) that are sent through wires included in the quantum hardware 1602. Further examples of control devices include arbitrary waveform generators, wherein a DAC (digital to analog converter) creates the signal.

The readout device(s) 1614 may be configured to perform quantum measurements on the quantum system 1610 and send measurement results 1608 to the classical processors 1604. In addition, the quantum hardware 1602 may be configured to receive data specifying physical control qubit parameter values 1606 from the classical processors 1604. The quantum hardware 1602 may use the received physical control qubit parameter values 1606 to update the action of the control device(s) 1612 and readout devices(s) 1614 on the quantum system 1610. For example, the quantum hardware 1602 may receive data specifying new values representing voltage strengths of one or more DACs included in the control devices 1612 and may update the action of the DACs on the quantum system 1610 accordingly. The classical processors 1604 may be configured to initialize the quantum system 1610 in an initial quantum state, e.g., by sending data to the quantum hardware 1602 specifying an initial set of parameters 1606.

The readout device(s) 1614 can take advantage of a difference in the impedance for the |0> and |1> states of an element of the quantum system, such as a qubit, to measure the state of the element (e.g., the qubit). For example, the resonance frequency of a readout resonator can take on different values when a qubit is in the state |0> or the state |1>, due to the nonlinearity of the qubit. Therefore, a microwave pulse reflected from the readout device 1614 carries an amplitude and phase shift that depend on the qubit state. In some implementations, a Purcell filter can be used in conjunction with the readout device(s) 1614 to impede microwave propagation at the qubit frequency.

In some implementations, the quantum system 1610 can include a plurality of qubits 1620 arranged, for instance, in a two-dimensional grid 1622. For clarity, the two-dimensional grid 1622 depicted in FIG. 1 includes 16 qubits arranged in a square formation, however in some implementations the system 1610 may include a smaller or a larger number of qubits. In some embodiments, the multiple qubits 1620 can interact with each other through multiple qubit couplers, e.g., qubit coupler 1624. The qubit couplers can define nearest neighbor interactions between the multiple qubits 1620. In some implementations, the strengths of the multiple qubit couplers are tunable parameters. In some cases, the multiple qubit couplers included in the quantum computing system 1600 may be couplers with a fixed coupling strength. In some implementations, the multiple qubits 1620 may include data qubits, such as qubit 1626 and measurement qubits, such as qubit 1628. A data qubit is a qubit that participates in a computation being performed by the system 1600. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 1620 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 1620 can be chosen before a computation is performed by the calibration system. Some operating frequencies are better than other operating frequencies. One metric for assessing how good a particular operating frequency is for a particular qubit is energy relaxation time (T1) for the qubit at the frequency. Lower energy relaxation times can lead to larger quantum computational errors.

In various implementations, the example system 1600 can be implemented as a client device, a server device, or both. The example system 1600 can be implemented as part of a distributed computing system. The example system 1600 can be implemented along with other example systems, which may be the same or different. The example system 1600 can be implemented in a server farm or other facility that operates multiple computing systems to provide computational services to or on behalf of a plurality of client systems. Advantageously, techniques according to example aspects of the present disclosure can provide for improved calibration and maintenance of computing facilities, increasing service uptime, decreasing failure rates, etc.

FIG. 17 depicts a block diagram of an example computing system 5 that can perform aspects of example embodiments of the present disclosure. The system 5 includes a computing device 50, a server computing system 60, and a third-party system 70 that are communicatively coupled over a network 49. The system 5 also includes a quantum computing system 80 that is communicatively coupled to the server computing system.

The computing device 50 can be any type of computing device (e.g., classical computing device), such as, for example, a mobile computing device (e.g., smartphone or tablet), a personal computing device (e.g., laptop or desktop), a workstation, a cluster, a gaming console or controller, a wearable computing device, an embedded computing device, or any other type of computing device. In some embodiments, the computing device 50 can be a client computing device or a server computing device. The computing device 50 can include one or more processors 51 and a memory 52. The one or more processors 51 can be any suitable processing device (e.g., a processor core, a microprocessor, an ASIC, an FPGA, a controller, a microcontroller, etc.) and can be one processor or a plurality of processors that are operatively connected. The memory 52 can include one or more non-transitory computer-readable storage media, such as RAM, ROM, EEPROM, EPROM, flash memory devices, magnetic disks, etc., and combinations thereof. The memory 52 can store data 53 and instructions 54 which are executed by the processor 51 to cause the user computing device 50 to perform operations as described herein.

The computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The quantum computing system 80 can include one or more processors 81 (e.g., classical processor(s) 1604) and a memory 82. The one or more processors 81 can be any suitable processing device (e.g., a processor core, a microprocessor, an ASIC, an FPGA, a controller, a microcontroller, etc.) and can be one processor or a plurality of processors that are operatively connected. The memory 82 can include one or more non-transitory computer-readable storage media, such as RAM, ROM, EEPROM, EPROM, flash memory devices, magnetic disks, etc., and combinations thereof. The memory 82 can store data 83 and instructions 84 which are executed by the processor 81 to cause the quantum computing system 80 to perform operations as described herein.

The quantum computing system 80 can also include a quantum system 85 for performing quantum computations. In some instances, the quantum system 85 can be, comprise, or be comprised by quantum hardware 1602, described above with reference to FIG. 16.

In some implementations, the quantum computing system can 80 include or be otherwise implemented by one or more server computing systems 60. In instances in which the quantum computing system 80 includes plural server computing devices, such server computing devices can operate according to sequential computing architectures, parallel computing architectures, or some combination thereof.

The third-party system 70 can include one or more processors 71 and a memory 72. The one or more processors 71 can be any suitable processing device (e.g., a processor core, a microprocessor, an ASIC, an FPGA, a controller, a microcontroller, etc.) and can be one processor or a plurality of processors that are operatively connected. The memory 72 can include one or more non-transitory computer-readable storage media, such as RAM, ROM, EEPROM, EPROM, flash memory devices, magnetic disks, etc., and combinations thereof. The memory 72 can store data 73 and instructions 74 which are executed by the processor 71 to cause the third-party system 70 to perform operations. In some implementations, the third-party system 70 includes or is otherwise implemented by one or more server computing devices.

The server computing system 60 can include one or more processors 61 and a memory 62. The one or more processors 61 can be any suitable processing device (e.g., a processor core, a microprocessor, an ASIC, an FPGA, a controller, a microcontroller, etc.) and can be one processor or a plurality of processors that are operatively connected. The memory 62 can include one or more non-transitory computer-readable storage media, such as RAM, ROM, EEPROM, EPROM, flash memory devices, magnetic disks, etc., and combinations thereof. The memory 62 can store data 63 and instructions 64 which are executed by the processor 61 to cause the server computing system 60 to perform operations. In some implementations, the server computing system 60 includes or is otherwise implemented by one or more server computing devices.

The network 49 can be any type of communications network (e.g., classical or quantum), such as a local area network (e.g., intranet), wide area network (e.g., Internet), or some combination thereof and can include any number of wired or wireless links. In general, communication over the network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

FIG. 17 illustrates one example computing system that can be used to implement the present disclosure. Other computing systems can be used as well. For example, in some implementations, the quantum computing system 80 can include the server computing system 60 or vice versa. In some implementations, the quantum computing system 80 may be communicatively coupled through the network 49 to the computing device 50, third-party system 70, or server computing system 60.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs (e.g., one or more modules of digital and/or quantum computer program instructions encoded on a tangible non-transitory storage medium for execution by, or to control the operation of, data processing apparatus). The digital and/or quantum computer storage medium can be a machine-readable storage device, a machine-readable storage substrate, a random or serial access memory device, one or more qubits/qubit structures, or a combination of one or more of them.

Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit (i.e., a system that defines the unit of quantum information). It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A method for fault-tolerant quantum computation, comprising:
measuring, at one or more mid-cycle states of a quantum error correction code executing on a quantum computing system, one or more mid-cycle gauge operators and one or more mid-cycle stabilizers; and
performing, based at least in part on a result of the measuring, a quantum error correction operation;
wherein the one or more mid-cycle gauge operators comprise one or more single-qubit mid-cycle gauge operators.

2. The method of claim 1, wherein:
the quantum computing system comprises a plurality of qubit structures and a plurality of couplers arranged in a topological grid; and
the topological grid comprises one or more dropout couplers that are not used in the quantum error correction code.

3. The method of claim 2, wherein the one or more dropout couplers comprise one or more faulty couplers.

4. The method of claim 2, wherein the topological grid comprises one or more dropout qubit structures that are not used in the quantum error correction code.

5. The method of claim 4, wherein the dropout qubit structures comprise one or more faulty qubit structures.

6. The method of claim 5, wherein the one or more faulty qubit structures comprise one or more qubit structures having an error rate metric that is worse than an error rate threshold.

7. The method of claim 2, wherein the one or more dropout couplers comprise a first dropout coupler associated with a first qubit structure and a second dropout coupler associated with the first qubit structure, and wherein the one or more single-qubit mid-cycle gauge operators comprise a first single-qubit mid-cycle gauge operator associated with the first qubit structure.

8. The method of claim 7, wherein the one or more mid-cycle gauge operators further comprise a multi-qubit gauge operator associated with a first set of qubit structures comprising one or more neighboring qubit structures that are adjacent to the first qubit structure in the topological grid.

9. The method of claim 8, further comprising determining, based at least in part on the multi-qubit gauge operator and the first single-qubit mid-cycle gauge operator, a mid-cycle stabilizer associated with the first qubit structure and the first set of qubit structures.

10. The method of claim 2, wherein the topological grid comprises a hexagonal grid.

11. The method of claim 10, wherein the one or more dropout couplers comprise a first dropout coupler associated with a first qubit structure and a second qubit structure, and the one or more single-qubit mid-cycle gauge operators comprise a first single-qubit mid-cycle gauge operator associated with the first qubit structure and a second single-qubit mid-cycle gauge operator associated with the second qubit structure.

12. The method of claim 11, wherein the one or more mid-cycle gauge operators further comprise a first multi-qubit gauge operator associated with a first set of qubit structures comprising one or more neighboring qubit structures of the first qubit structure and a second multi-qubit gauge operator associated with a second set of qubit structures comprising one or more neighboring qubit structures of the second qubit structure.

13. The method of claim 12, further comprising:
determining, based at least in part on the first multi-qubit gauge operator and the first single-qubit mid-cycle gauge operator, a first stabilizer associated with the first qubit structure and the neighboring qubit structures of the first qubit structure; and
determining, based at least in part on the second multi-qubit gauge operator and the second single-qubit mid-cycle gauge operator, a second stabilizer associated with the second qubit structure and the neighboring qubit structures of the second qubit structure.

14. The method of claim 10, wherein the one or more dropout couplers comprise a first dropout coupler associated with a first qubit structure and a second qubit structure, and wherein the one or more mid-cycle gauge operators comprise:
a first two-qubit gauge operator associated with the first qubit structure;
a second two-qubit gauge operator associated with the first qubit structure;
a third two-qubit gauge operator associated with the second qubit structure; and
a fourth two-qubit gauge operator associated with the second qubit structure.

15. The method of claim 14, further comprising:
determining, based at least in part on the first two-qubit gauge operator and the third two-qubit gauge operator, a first stabilizer associated with the first qubit structure and the second qubit structure; and
determining, based at least in part on the second two-qubit gauge operator and the fourth two-qubit gauge operator, a second stabilizer associated with the first qubit structure and the second qubit structure.

16. The method of claim 2, wherein the dropout couplers comprise first, second, third, and fourth dropout couplers arranged in a square formation, the first, second, third, and fourth dropout couplers associated with first, second, third, and fourth qubit structures arranged in a square formation; and
wherein the one or more single-qubit mid-cycle gauge operators comprise a first single-qubit mid-cycle gauge operator associated with the first qubit structure, a second single-qubit mid-cycle gauge operator associated with the second qubit structure, a third single-qubit mid-cycle gauge operator associated with the third qubit structure, and a fourth single-qubit mid-cycle gauge operator associated with the fourth qubit structure.

17. The method of claim 16, further comprising determining, based at least in part on the first, second, third, and fourth single-qubit mid-cycle gauge operators, a stabilizer associated with the first, second, third, and fourth qubit structures.

18. The method of claim 4, wherein the one or more dropout qubit structures comprise a first dropout qubit structure that is adjacent to a second qubit structure in the topological grid, wherein the second qubit structure is not a dropout qubit structure;
wherein the one or more dropout couplers comprise a first dropout coupler associated with the second qubit structure, wherein the first dropout coupler is not associated with the first dropout qubit structure in the topological grid; and
wherein the one or more single-qubit mid-cycle gauge operator comprise a first single-qubit mid-cycle gauge operator associated with the second qubit structure.

19. A quantum computing system comprising:
quantum hardware comprising a plurality of qubit structures and a plurality of couplers, the plurality of qubit structures arranged in a topological grid;
one or more readout devices configured to perform quantum measurements on the quantum hardware; and
one or more control devices configured to cause the quantum computing system to perform operations, the operations comprising:
measuring, at one or more mid-cycle states of a quantum error correction code executing on a quantum computing system, one or more mid-cycle gauge operators and one or more mid-cycle stabilizers, wherein the one or more mid-cycle gauge operators comprise one or more single-qubit mid-cycle gauge operators; and
performing, based at least in part on the one or more single-qubit mid-cycle gauge operators, a quantum error correction operation.

20. A method comprising:
determining, based at least in part on a set of dropout quantum devices of a set of quantum devices of a quantum computing system, a set of mid-cycle gauge operators, the set of mid-cycle gauge operators comprising one or more single-qubit mid-cycle gauge operators;
determining, based at least in part on the set of dropout quantum devices, a modified quantum error correction code that can be performed without using the dropout quantum devices, wherein the modified quantum error correction code comprises determining one or more mid-cycle stabilizers based at least in part on the one or more single-qubit mid-cycle gauge operators; and
implementing, using the quantum computing system, the modified quantum error correction code.
